(19) United States
(12) Patent Application Publication
(10) Pub. No.: US 2012/0262484 A1
(43) Pub. Date: Oct. 18, 2012

(54) Motion Capture and Analysis at a Portable Computing Device

(75) Inventors: David William Gottfeld, Monrovia, MD (US); Robert Douglas Harris, Potomac, MD (US); Todd Austin Wright, Austin, TX (US)

(73) Assignee: KINESIOCAPTURE, LLC, Bethesda, MD (US)

(21) Appl. No.: 13/419,924

(22) Filed: Mar. 14, 2012

Related U.S. Application Data
(60) Provisional application No. 61/474,388, filed on Apr. 12, 2011.
(60) Provisional application No. 61/581,461, filed on Dec. 29, 2011.

(51) Int. Cl. G09G 5/377; G06F 3/041

(52) U.S. Cl. 345/632

(57) ABSTRACT

Embodiments of the present invention are generally directed to devices, methods and instructions encoded on computer readable media for capturing motion and analyzing the captured motion at a portable computing device. In one exemplary embodiment, a motion capture and analysis application is provided. The application, when executed on a portable computing device, is configured to capture video of a subject (i.e., person) while the subject performs a selected action. The motion capture and analysis application provides various tools that allow an application user (e.g., trainer) to evaluate the motion of the subject during performance of the action.

### CROSS-REFERENCE TO RELATED APPLICATIONS

This application claims the benefit of U.S. Patent Application No. 61/474,388 filed on Apr. 12, 2011, and U.S. Provisional Patent Applications No. 61/581,461 filed on Dec. 13, 2011. These provisional applications are hereby incorporated by reference herein.

### BACKGROUND

1. Technical Field

The present invention relates generally to motion capture and analysis at a portable computing device.

2. Related Art

There is a wide variety of available information that is directed to improving sport performance or injury rehabilitation. This information includes books, brochures, videos, Websites, etc. While this information may provide insight into “proper” techniques (i.e., posture, throwing or kicking motion, grip, and the like), none of this information is tailored to specific individuals having certain needs or physical limitations. For example, while the “proper” swing for a professional baseball player may be to swing a bat with a particular order and combination of feet, hips, head, wrist, arm, and shoulder motion, such a swing may be considered improper for a child learning how to hit a baseball with a bat.

Consequently, individuals often turn to other sources, such as personal trainers, instructors, coaches, therapists, etc. (collectively and generally referred to herein as trainers), for assistance in improving sport performance and/or for rehabilitation needs. A trainer can tailor training sessions for a specific individual based on personal factors (e.g., the individual's age, fitness level, current techniques, etc.). By combining personal factors with observations of the individual, the trainer can analyze the individual's performance and recommend certain adjustments or practice routines that are likely to improve performance.

The enormous advancements in technology have generated a push to develop motion training and/or analysis systems for use by trainers to evaluate and improve an individual's performance. However, conventional systems suffer from many drawbacks that have limited their use by trainers. For example, conventional systems are often difficult to use and calibrate, are not interactive, and do not provide instantaneous feedback. Therefore, a need exists for a simple and easy-to-use motion analysis system which enables a trainer to quickly and effective evaluate an individual's performance of a selected motion.

### SUMMARY

In certain embodiments of the present invention, a method is provided. The method comprises obtaining a video of a subject at a portable computing device, displaying a still-frame image of the video at a touch screen of the portable computing device, and superimposing (overlaying) one or more image evaluation tools onto the still-frame image in response to one or more touch inputs received at the touch screen.

In other embodiments of the present invention, one or more computer readable storage media encoded with software comprising computer executable instructions are provided. The one or more computer readable storage media are encoded with instructions that, when executed, are operable to obtain a video of a subject at a portable computing device, display a still-frame image of the video at a touch screen of the portable computing device, and superimpose (overlay) one or more image evaluation tools onto the still-frame image in response to one or more touch inputs received at the touch screen.

In still other embodiments of the present invention, a portable computing device is provided. The portable computing device comprises a touch screen and a processor configured to obtain a video of a subject at a portable computing device, display a still-frame image of the video at the touch screen, and to superimpose one or more image evaluation tools onto the still-frame image in response to one or more touch inputs received at the touch screen.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and will be apparent to those skilled in the art based on the descriptions herein.

### BRIEF DESCRIPTION OF THE DRAWINGS

Embodiments of the present invention are described herein in conjunction with the accompanying drawings, in which:

FIG. 1 is block diagram of a portable computing device in which an exemplary motion capture and analysis application may be executed;

FIG. 2 is a schematic diagram of an exemplary home screen for the motion capture and analysis application;

FIG. 3 is a schematic diagram of an exemplary add session screen for the motion capture and analysis application;

FIG. 4 is a schematic diagram of an exemplary pop-up window for adding a photograph to the screen of FIG. 3;

FIGS. 5-20 are schematic diagrams illustrating various features and tools provided by the motion capture and analysis application;

FIG. 21 is a flowchart of a method for simulcasting two videos with the motion capture and analysis application;

FIGS. 22-25 are schematic diagrams illustrating additional features and tools of the motion capture and analysis application;

FIG. 26 is a flowchart of a method for generating an estimate of the actual distance in an image displayed through the motion capture and analysis application;

FIGS. 27-29 are schematic diagrams illustrating further features and tools of the motion capture and analysis application;

FIG. 30 is a flowchart of a method for superimposing a grid onto a image displayed through the motion capture and analysis application;

FIG. 31 is a schematic diagram illustrating another feature of the motion capture and analysis application;

FIG. 32 is a flowchart of a method for superimposing a bully's-eye onto a image displayed through the motion capture and analysis application;

FIG. 33 is a schematic diagram illustrating integration features of the motion capture and analysis application; and

FIG. 34 is a high-level flowchart of a method executed a portable computing device in accordance with embodiments of the present invention.

### DETAILED DESCRIPTION

Embodiments of the present invention are generally directed to devices, methods and instructions encoded on computer readable media for capturing motion and analyzing the captured motion at a portable computing device. In one exemplary embodiment, a motion capture and analysis application is provided. The application, when executed on a portable computing device, is configured to capture video of a subject (i.e., person) while the subject performs a selected action. The motion capture and analysis application provides various tools that allow an application user (e.g., trainer) to evaluate the motion of the subject during performance of the action.

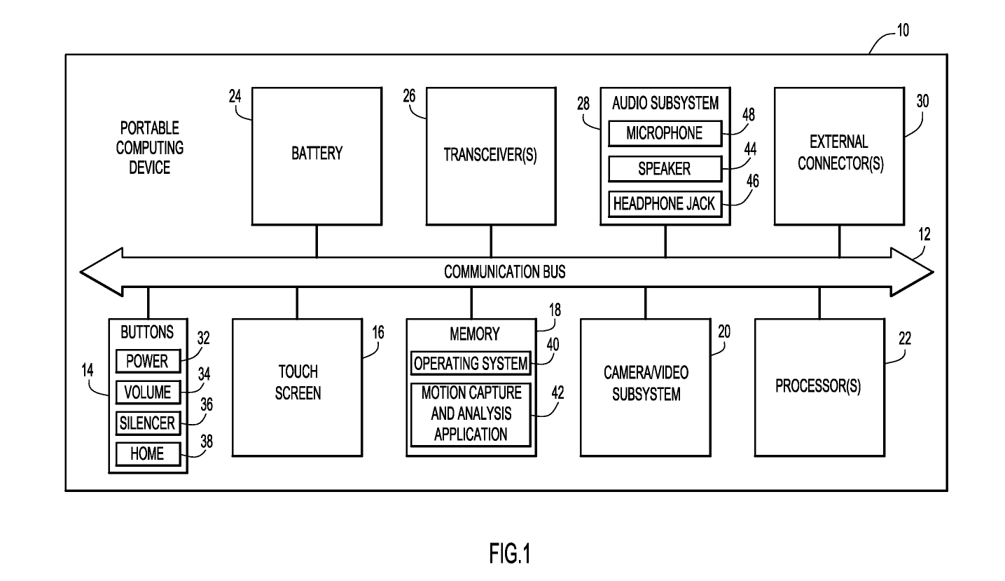

FIG. 1 is a block diagram of an exemplary portable computing device 10 in which a motion capture and analysis application in accordance with embodiments of the present invention may be executed. Portable computing device 10 may be a tablet computer, laptop computer, mobile phone, personal digital assistant (PDA), etc. In one specific embodiment, portable computing device 10 is an iPad® 2 tablet computer. IPad is a registered trademark of Apple Inc., 1 Infinite Loop Cupertino, Calif. 95014.

Portable computing device 10 comprises various functional components that are coupled together by a communication bus 12. These components include buttons 14, a touch screen 16, a memory 18, a camera/video subsystem 20, processor(s) 22, a battery 24, transceiver(s) 26, an audio subsystem 28, and external connector(s) 30.

Touch screen 16 is an electronic visual display that couples a touch sensor/panel with a display screen. In operation, the display screen is configured to display different images, graphics, text, etc., that may be manipulated through a user's touch input. More specifically, the user contacts the display screen with a finger or stylus, and the touch sensor detects the presence and location of the user's touch input within the display screen area. The user's touch input is correlated with the display screen so that an active connection with the display is created. As described in further detail below, touch screen 16 is the main user interface that provides control of the operation of portable computing device 10, as well as the motion capture and analysis application.

Also provided for the control of portable computing device 10 are buttons 14. Buttons 14 include a power button 32, a volume button 34, a silencer button 36, and a home button 38. Home button 38 may be an indented button positioned directly below the touch screen 16. When home button 38 is actuated, the portable computing device 10 will return to a predetermined home screen. The power button 32 may allow a user to power on/off the portable computing device 10, place the device in a sleep mode, and/or wake the device from the sleep mode. Additionally, the silencer button 36 is a toggle switch that silences all sounds, and volume button 34 is an up/down rocker switch that controls the volume of such sounds. The power button 32, silencer button 36, and volume button 34 may all be positioned along an edge of the portable computing device 10.

Memory 18 is a tangible data structure encoded with software for execution by processor(s) 22. Memory 18 may comprise read only memory (ROM), random access memory (RAM), magnetic disk storage media devices, optical storage media devices, flash memory devices, electrical, optical, or other physical/tangible memory storage devices. In one example, stored in memory 18 is an operating system 40 and motion capture and analysis application 42. The processor(s) 22 are, for example, microprocessors or microcontrollers that execute instructions for the operating system 40 and the motion capture and analysis application 42.

As is well known in the art, operating system 40 is a set of programs that manage computer hardware resources and provide common services for software applications. Motion capture and analysis application 42 is a software application that, when executed by processor(s) 22, is configured to capture video of a subject and provide tools for subsequent analysis of the captured video.

Camera/video subsystem 20 includes an integrated camera and video recorder. Camera/video subsystem 20 is controlled by motion capture and analysis application 42 to enable a user to capture video, snapshots, and photographs of a subject. Camera/video subsystem 20 may include various hardware components that support the capture of videos, snapshots, and photographs.

Battery 24 is a rechargeable battery that supplies power to the other components of portable computing device 10. Transceiver(s) 26 are devices configured to transmit and/or receive information via one or more wireless communication links. Transceiver(s) 26 may comprise Wi-Fi transceivers, Bluetooth transceivers, etc. Audio subsystem 28 includes various hardware components for providing audio input/output functions for the portable computing device 10. Audio subsystem 28 includes a speaker 44, a headphone jack 46, and a microphone 48.

Finally, portable computing device 10 includes one or more external connector(s) 30. External connector(s) 30 may include a Universal Serial Bus (USB) port, a mini-USB port, a multi-pin connector, etc.

The portable computing device 10 of FIG. 1 has been described with reference to basic hardware and software components of the device. It will be appreciated that portable computing device 10 may include additional components that support the functionality described elsewhere herein. For ease of illustration, such components have been omitted from FIG. 1. Additionally, the various components have been functionally shown as a plurality of separate blocks. It will be appreciated that the various components may be implemented, for example, as digital logic gates in one or more Application Specific Integrated Circuits (ASICs).

The following provides a detailed description of the operation of motion capture and analysis application 42 executed on portable computing device 10. As detailed below, the motion capture and analysis application 42 is configured to display various fields, icons, buttons, or other elements on touch screen 16 that allow a user to activate features/tools of the application. The following description refers to the activation of these features of motion capture and analysis application 42 by “tapping” the different displayed elements. It is to be understood that tapping of an element refers to a user's touch input on to the portion of the touch screen 16 where the element is displayed.

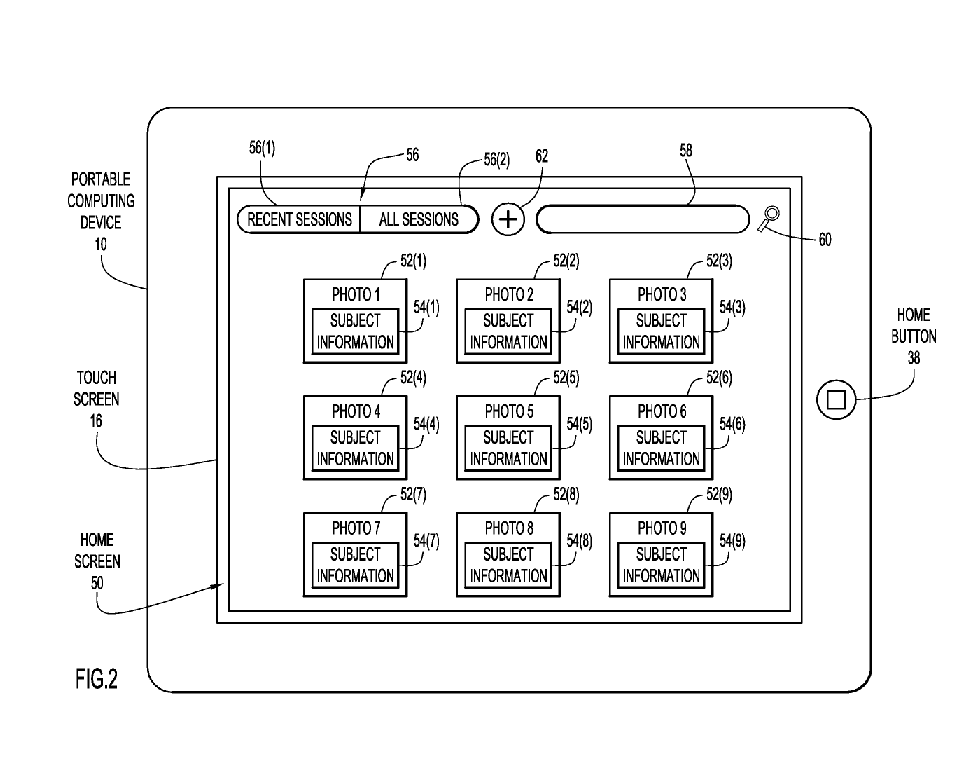

FIG. 2 is a schematic diagram illustrating the front view of portable computing device 10. Shown in FIG. 2 are the touch screen 16 and the home button 38. Displayed on touch screen 16 is a home screen 50 for motion capture and analysis application 42. When motion analysis application 42 is initially launched (i.e., activated by a user), a splash screen will initially appear and fade away to home screen 50. Home screen 50 is a screen that displays a pictorial list of previously recorded and currently accessible “sessions” 52(1)-52(9). Each session corresponds to a previous recording of a subject performing a selected action. In the embodiment of FIG. 2, the sessions 52(1)-52(9) are listed by showing a photo of the subject (i.e., the subject captured during the recording). Displayed or superimposed on each photo 52(1)-52(9) is information 54(1)-54(9) associated with the respective subject. This information 54(1)-54(9) may include the subject's name, age, sex, date the session was recorded, etc. The user can tap on any of the listed sessions 52(1)-52(9) to view the details of the session.

Shown on home screen 50 is a filter bar 56 that allows a user to select how the sessions are displayed on the home screen. In this example, filter bar 56 has two filter options 56(1) and 56(2). Option 56(1) is referred to as the recent session option that causes the most recently recorded sessions to be displayed on the home screen 50. In one embodiment, option 56(1) is the default option. Option 56(2) is referred to as the all sessions option that causes all previously recorded sessions to be listed on the home screen 50. The options 56(1) and 56(2) may be selected by tapping the respective portions of the filter bar 56.

In each of options 56(1) and 56(2), the sessions may be listed in the alphabetical order of the subject's last name. Alternatively, the sessions may be listed in order of the date of the session was recorded, with the newest sessions appearing at the beginning of the list.

Home screen 50 also includes a search bar 58 that allows the user to search for a particular session. This search may be conducted by using a subject's last name, by using a date of a session, or by using other information associated with a session. The search is activated by tapping the search bar 58, entering the first portion of the search string (e.g., first few letters of the last name), and finally by tapping the search icon 60.

It is to be appreciated that there may be multiple sessions for each subject. That is, video of a subject may have been captured at various different times. In one embodiment each of the different sessions associated with a subject may be grouped together under one photo for the subject. In an alternative embodiment, the different sessions associated with a subject may be separately displayed.

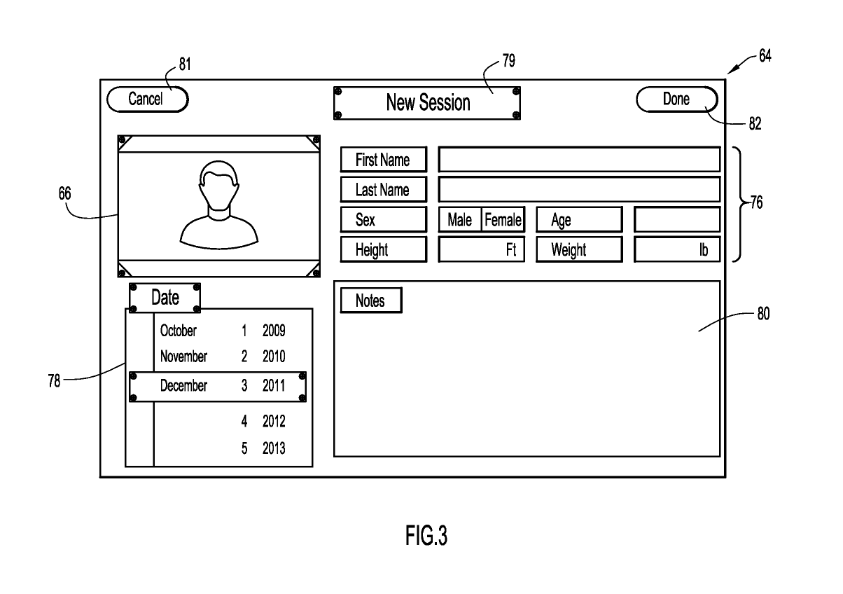

Home screen 50 also includes an add session icon 62. When this add session icon 62 is tapped, an add session screen is activated that allows the user to create a new session. FIG. 3 is a schematic diagram of an exemplary add session screen 64 in accordance with one embodiment of the present invention.

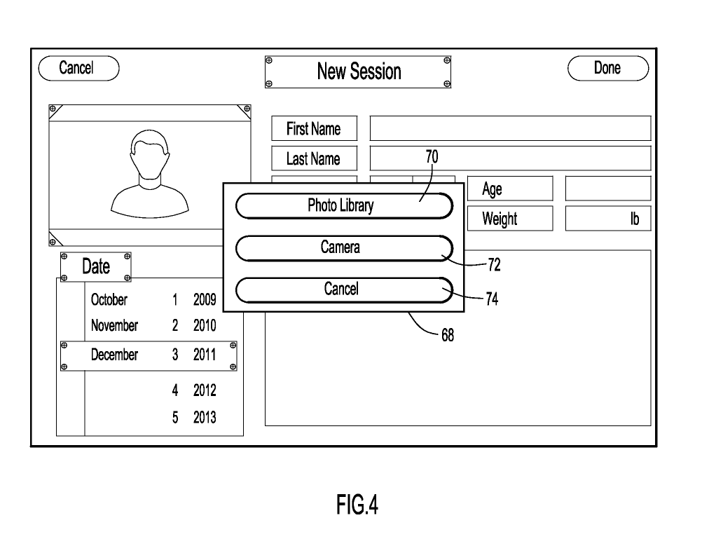

The add session screen 64 includes a photograph section 66 that allows the user to store a photograph of the subject associated with the new session. To add a photograph, the user will tap section 66 and a pop-up window 68 (shown in FIG. 4) will appear. The pop-up window 68 includes a camera option 70 that allows the user to take a photograph of the subject. The pop-up window 68 also includes a photo library option 72 that allows the user to select a photograph from the photo library stored in memory 18. Also shown is a cancel option 74 that allows the user to return to the add session screen 64 without adding a photograph.

Returning to FIG. 3, the add session screen 64 includes several data fields 76 that allow the user to enter information about the subject. In the embodiment of FIG. 3, data fields are provided for entry of the subject's first name, last name, sex, age, height, and weight. When the user taps each of these fields, a pop-up keyboard or option bar is provided that allows the user to enter the desired information.

Add screen 64 also includes a date field 78 and a notes field 80. The date field 78 allows the user to enter the date of the session. The notes field 80 allows the user to enter general information regarding the subject, the training session, etc. The user may also add a title to the session using title field 79. Addition of the new session may be cancelled using the cancel icon 81.

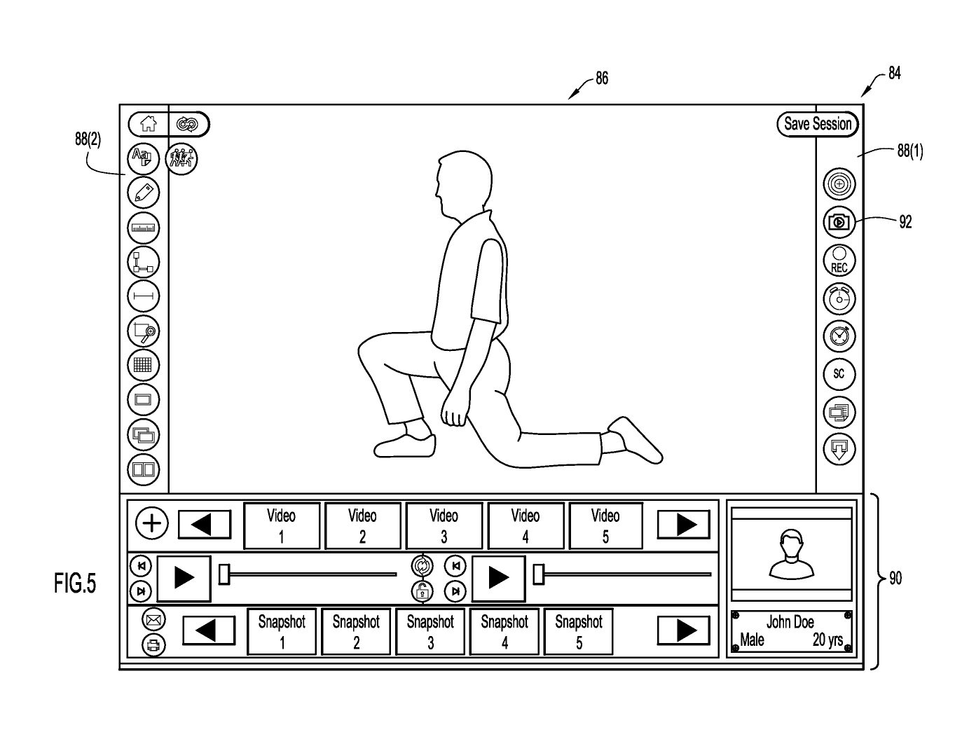

After the desired information for a new session has been entered at screen 64, the user will tap the done icon 82. This action causes the motion capture and analysis application 42 to display a control screen 84. Control screen 84 is shown in FIGS. 5-20, 22-25, 27-29, 31, and 33. Control screen 84 may be generally divided into several different sections that include the video area 86, a first tool bar 88(1), a second toolbar 88(2), and a video bar 90. The first tool bar 88(1), second toolbar 88(2), and video bar 90 include various icons that will be individually introduced and described with reference to each of the FIGS. 5-20, 22-25, 27-29, 31, and 33. It is to be appreciated that the locations and format of the various control icons in FIGS. 5-20, 22-25, 27-29, 31, and 33 in the toolbars 88(1) and 88(2), as well as in video bar 90, are merely illustrative.

In embodiments of the present invention, the motion capture and analysis application 42 may operate video area 86 in different modes. The first mode is referred to n as the video mode and the second mode is referred to as the live mode. In the video mode, the video area 86 is configured to display a previously recorded video. In the live mode, the video area 86 is configured to display a real-time view of the image that is currently being captured by the camera/video subsystem 20.

A first feature of the motion analysis application 42 is the ability to take photographs via the camera/video subsystem 20. Therefore, as shown in FIG. 5, toolbar 88(1) includes a camera icon 92. When this camera icon 92 is tapped while watching a video (i.e., while in video mode), the motion analysis application 42 will switch the video area 86 to the live mode. Once in the live mode, the user could take a photograph of the image displayed in video area 86. In one embodiment, camera icon 92 may be used to take a photograph of a subject for use in his/her session(s).

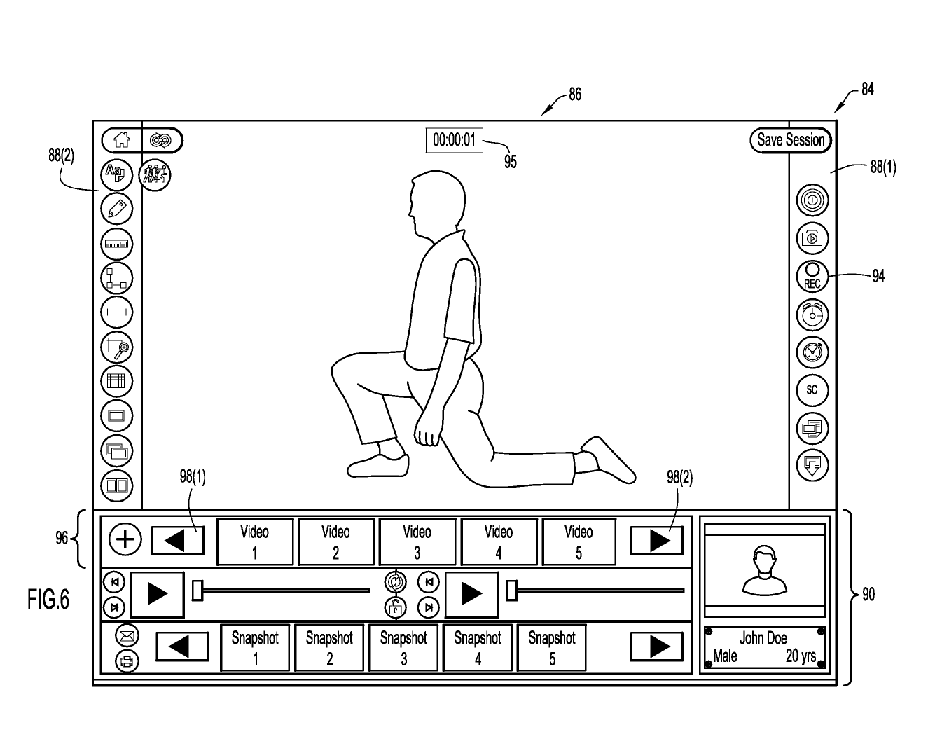

Another feature of the motion capture and analysis application 42 is the ability to capture video of a subject while performing an action. As such, toolbar 88(1) includes a record icon 94 that is identified in FIG. 6. When this record icon 94 is tapped while watching a video (i.e., while in video mode), the motion capture and analysis application 42 will switch the video area 86 to the live mode. Once in the live mode, a user will again tap the record icon 94 to begin recording a video. During recording of the video, a counter 95 may be displayed in video area 86. The counter 95 shows the current length of the video as it is recorded. The user terminates recording of the video by again tapping the record icon 94.

In one embodiment, motion capture and analysis application 42 supports voice activated recording of a video. In such embodiments, when the video area 86 is in the live mode, the user can say a command such as “record” or “start recording” to begin recording of a video. Similarly, the user may say a command such as “stop recording” or “stop” to terminate the recording. In operation, the voice commands would be detected by microphone 48.

Video bar 90 includes a video list 96 that displays a thumbnail list of recently recorded videos. When recording of the video is completed, the video is added to the foremost (left-most) position in video list 96. Video list 96 includes a forward icon 98(1) and a backward icon 98(2) that allow the user to scroll through the videos in the video list.

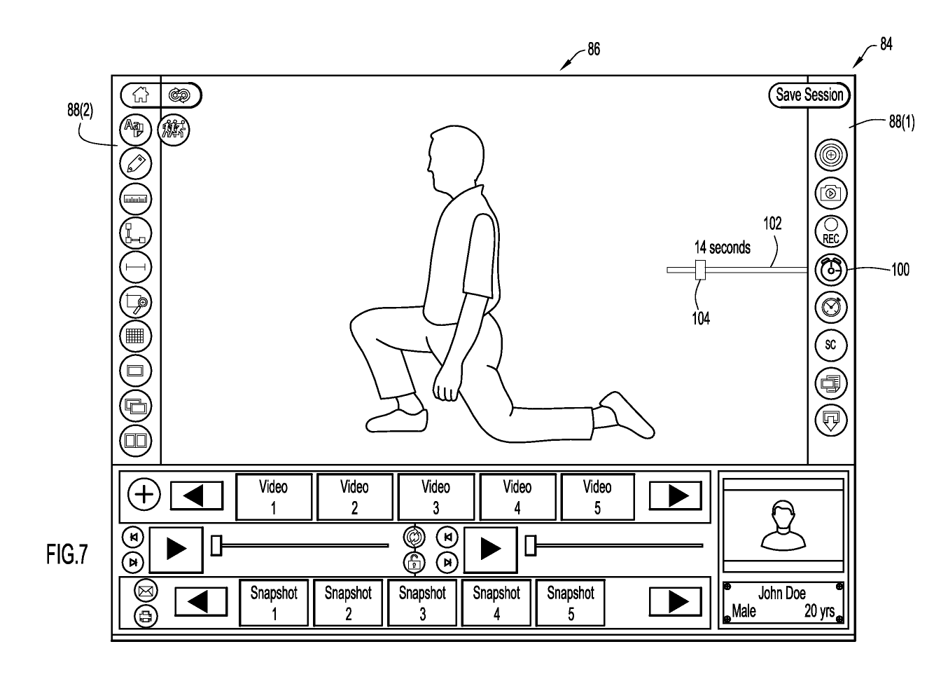

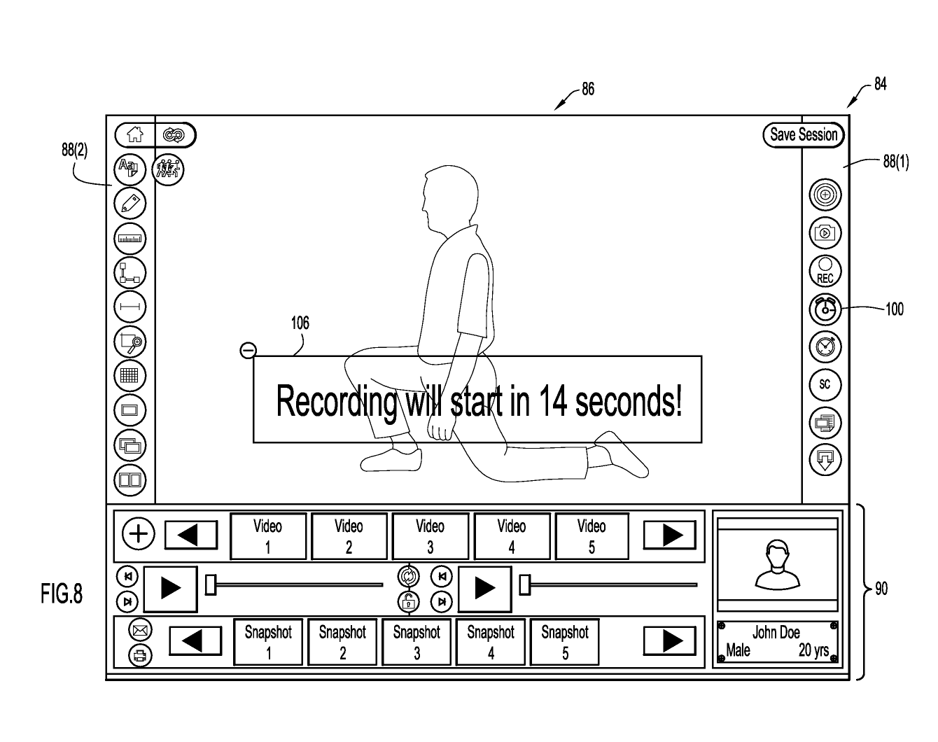

FIG. 7 is a schematic diagram of control screen 84 that identifies a delayed recording icon 100. When delayed recording icon 100 is tapped, a timer bar 102 is superimposed onto video area 86. Timer bar 102 includes a slider 104. By moving the slider 104 in timer slide 104, the user may set a delayed time at which the camera/video subsystem 20 will begin recording a video. In one embodiment, the delay is up to 20 seconds. As shown in FIG. 8, once the timer is started, a countdown pop-up window 106 will be displayed in video area 86.

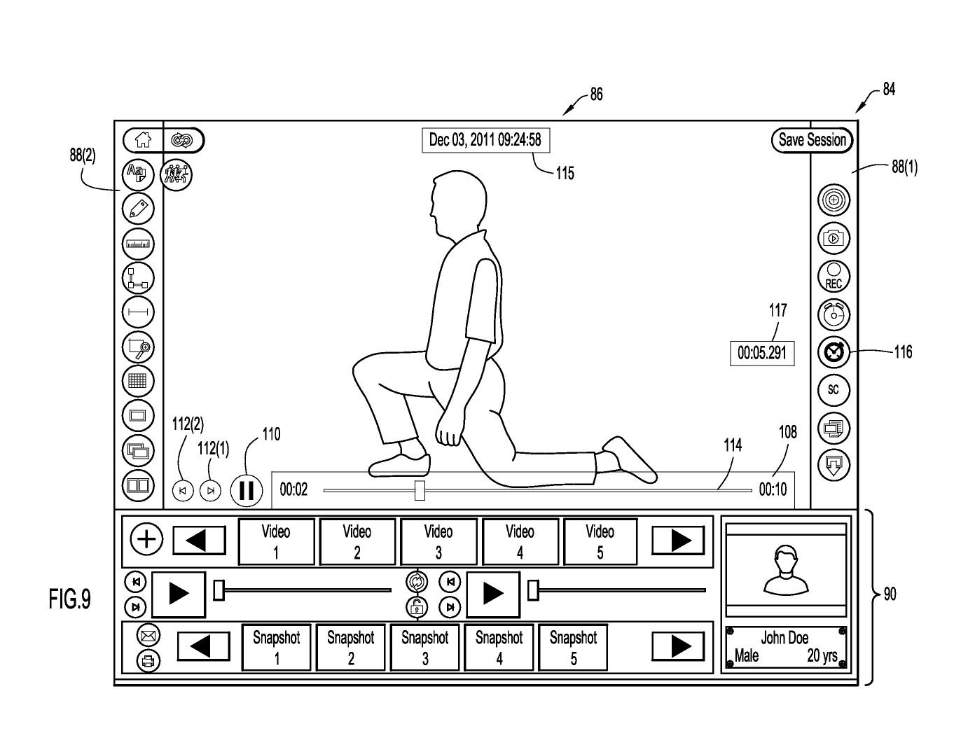

Once a video is captured, the video may be played in video area 86. As shown in FIG. 9, when a video is prepared for playback, a control bar 108 is superimposed on the video area 86. Control bar 108 includes a start/stop icon 110, forward and reverse icons 112(1) and 112(2), respectively, and a progress bar 114. The user may start or stop the video by tapping start/stop icon 110. It is to be appreciated that start/stop icon 110 is a dynamic icon that will change depending on whether video playback is in progress or the video is stopped. More specifically, the icon displays two vertical lines while video playback is in progress and an arrow when the video is stopped. The video area 86 may also include a timestamp 115 that displays the time the video was originally captured.

FIG. 9 also illustrates a stopwatch icon 116 that activates a stopwatch feature. The stopwatch feature allows the user to determine the duration of an event captured in a video displayed in video area 86. More specifically, by tapping stopwatch icon 116, a timer will set so as to start and stop with the start/stop icon 110. In other words, tapping the stopwatch icon 116 synchronizes the stopwatch to the video. In certain embodiments, the stopwatch icon 116 may be moved anywhere in the video area 86. The time (in seconds) of the captured event may be displayed at a timer bar 117 in video area 86.

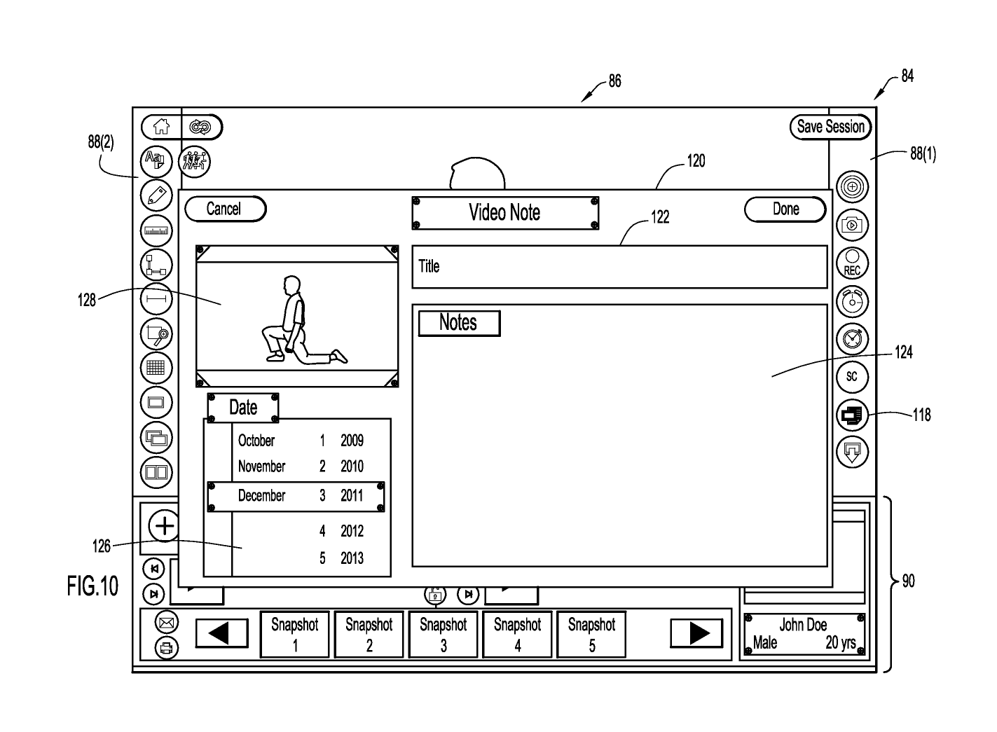

FIG. 10 illustrates a video note window 120 that is activated by tapping video note icon 118. Video note window 120 includes various fields that allow the user to enter remarks and information relevant to a captured video. The available fields may include a title field 122, a notes field 124, a date field 126, and a window 128 that includes a thumbnail image of the captured video.

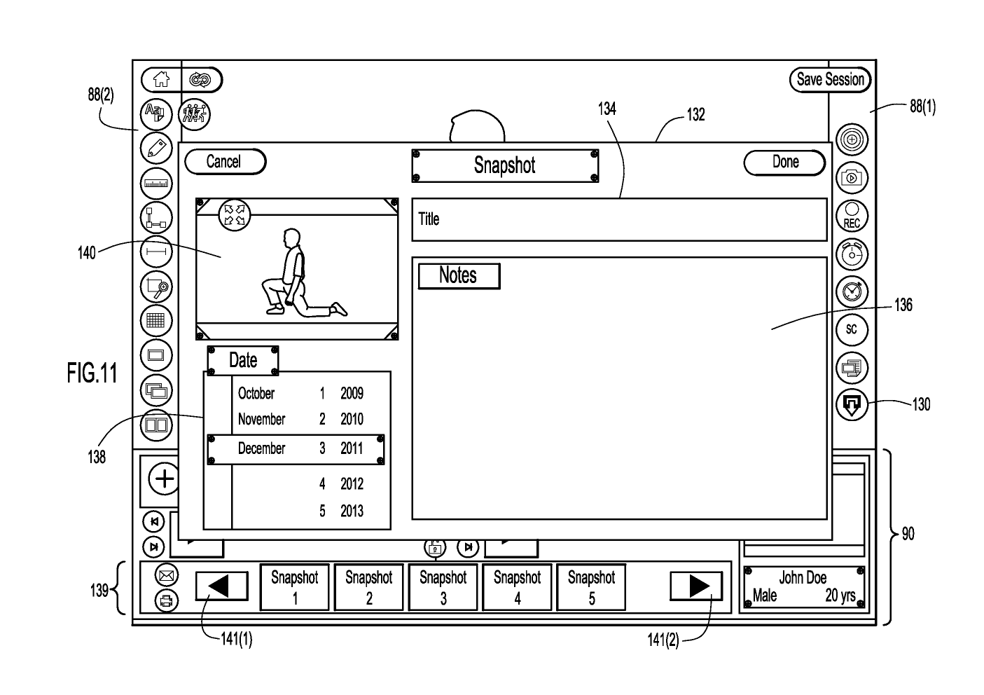

A further feature of the motion capture and analysis application 42 is the ability to capture still-frame images or snapshots of a captured video. As such, identified in FIG. 11 is a snapshot icon 130 positioned in toolbar 88(1). To take a snapshot, the user will stop playback of the video and tap the snapshot icon 130 to activate snapshot window 132. Snapshot window 132 includes various fields that allow the user to enter remarks and information relevant to the captured snapshot. The available fields may include a title field 134, a notes field 136, a date field 138, and a window 140 that includes a thumbnail image of the captured snapshot.

Once a snapshot is captured, the snapshot is added to the foremost (left-most) position in a snapshot list 139 in video bar 90. Snapshot list 139 includes a forward icon 141(1) and a backward icon 141(2) that allow the user to scroll through the snapshots in the snapshot list.

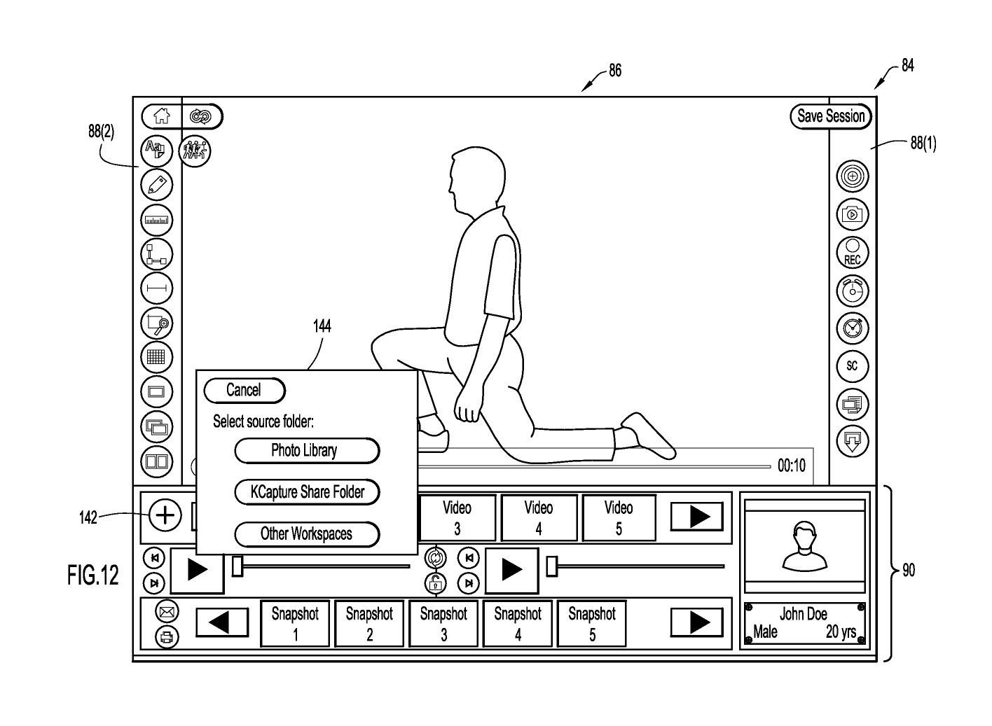

As described above, videos may be captured in real-time and added to video list 96 in video bar 90. Motion capture and analysis application 42 also has the ability to add previously recorded videos to video list 96. To enable this feature, video bar 90 includes an add video icon 142 that is identified in FIG. 12. To add a video, the user taps the add video icon 142 and a window 144 appears. The window 144 includes links to various sources of previously stored videos, including a link to a photo library, a link to a share folder, and a link to other workspaces. The photo library is stored in memory 18 of the portable computing device and is sometimes referred to as a camera roll. The share folder allows for the addition of files from a wired or wirelessly connected computer or data storage device. Finally, the link to other workspaces allows for the addition of files from another subject's profile. Once a video is added to the video list 96, the video may be selected by the user for playback in video area 86.

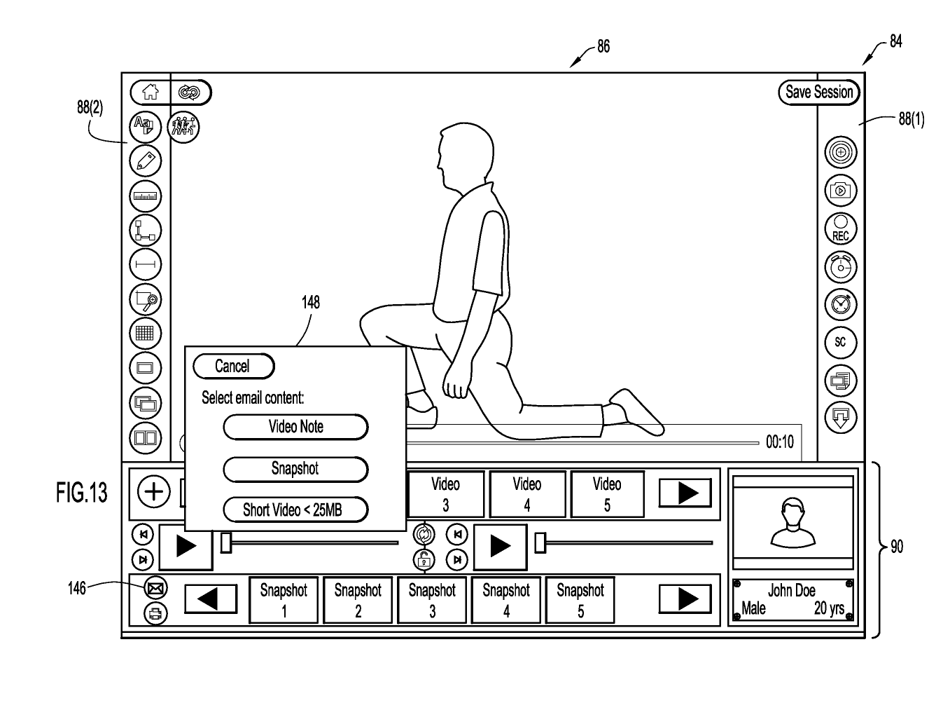

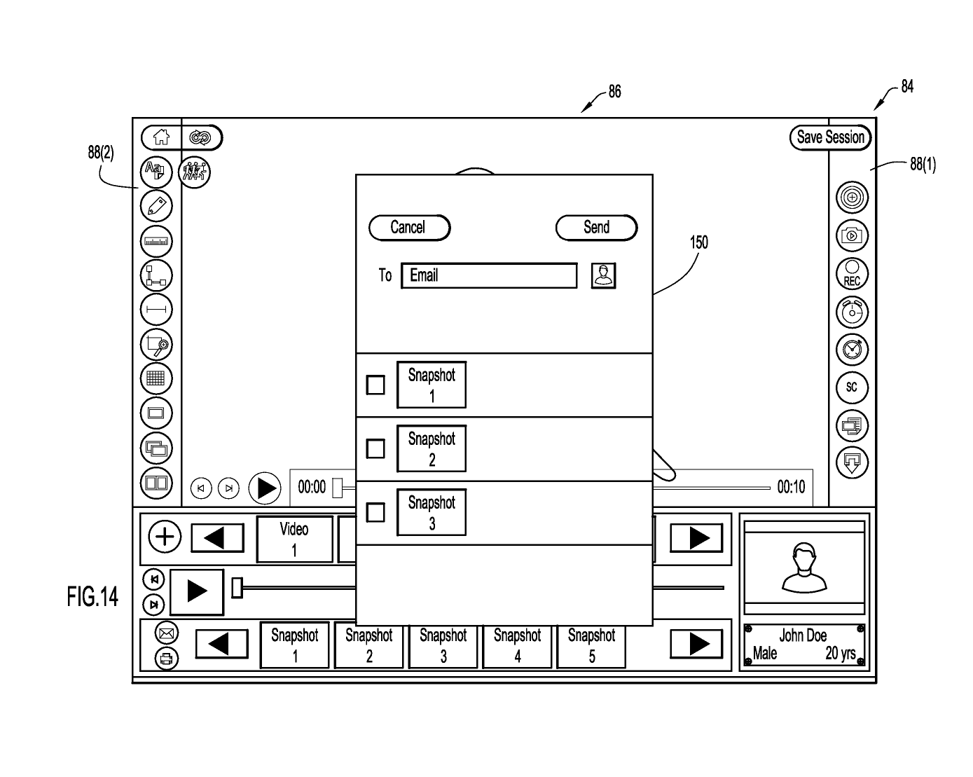

Identified in FIG. 13 is an email icon 146 that allows a user to send snapshots or videos as attachments to an email. When the user taps email icon 146, a content selection window 148 is activated that allows the user to select the content of the email (i.e., snapshot or video). After at least a first piece of content is selected, an email window 150 (shown in FIG. 14) is displayed. From this window 150, the user can send an email with the selected content. The user can also use this window 150 to attach additional content and/or remove content. In one embodiment, the size of the content attached to an email should be below a predetermined size, such as 25 megabytes (MBs). A notification may be displayed to the user when the content exceeds this predetermined limit

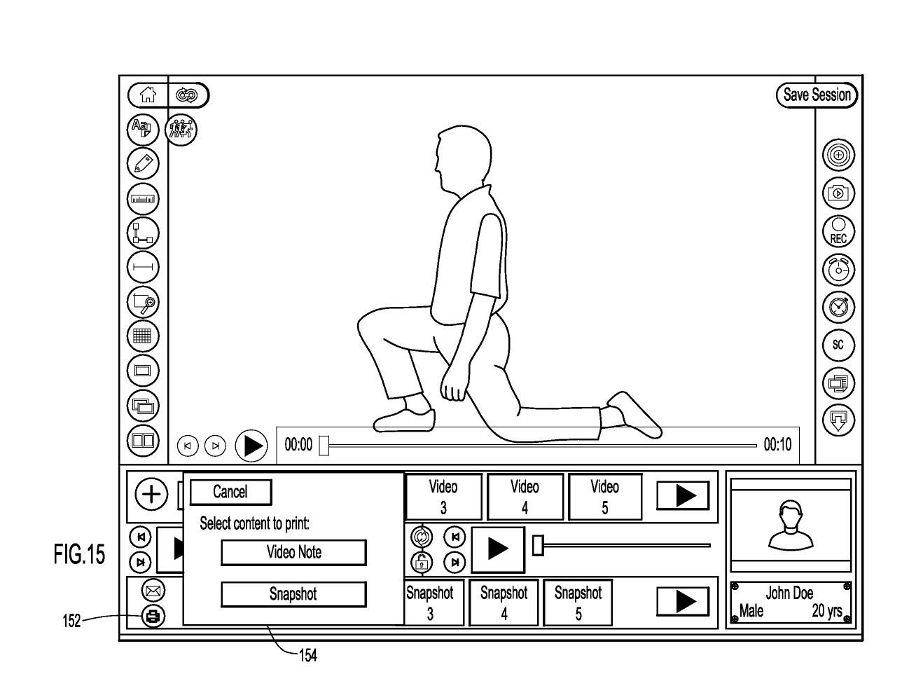

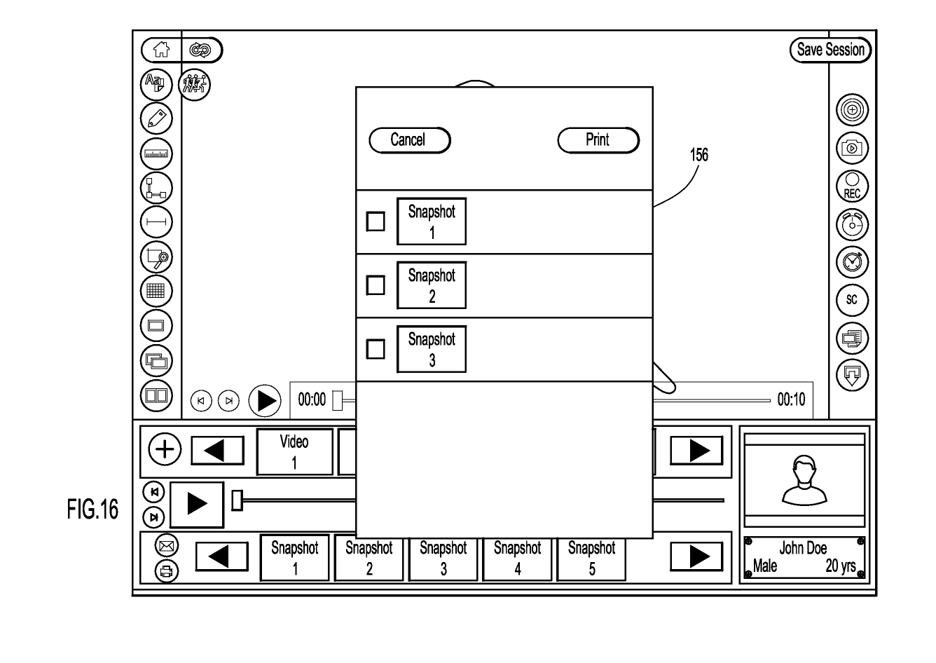

Identified in FIG. 15 is a print icon 152 that allows a user to print snapshots or video notes. When user taps print icon 152, a content selection window 154 is activated that allows the user to select the content to be printed (i.e., snapshot or video note). After at least a first piece of content is selected, a print window 156, shown in FIG. 16, is displayed. From this window 156, the user can print the selected content. The user can also use this window to select additional content and/or remove content.

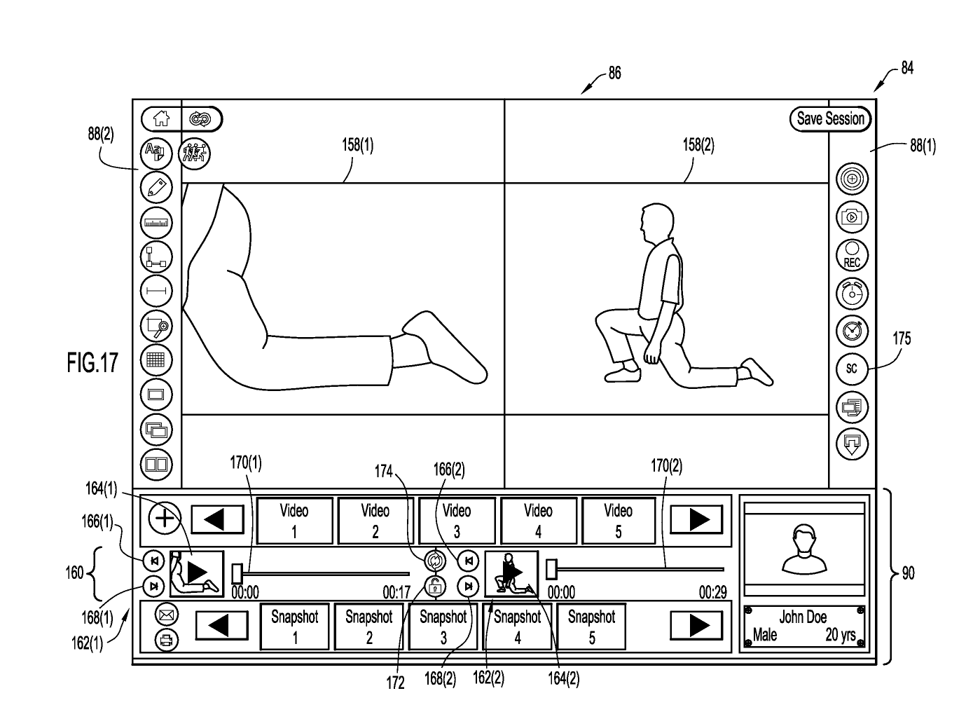

FIG. 17 illustrates an embodiment of the present invention in which it is possible to simultaneously display and playback two videos in video area 86. As shown, first and second videos 158(1) and 158(2), respectively, are displayed side-by-side in video area 86. In this embodiment, video area 86 is equally divided so that videos 158(1) and 158(2) are substantially the same size. Playback of videos 158(1) and 158(2) is controlled by simultaneous playback bar 160. Simultaneous playback bar 160 includes two sections 162(1) and 162(2) for independent control and playback of each of the videos 158(1) and 158(2). Sections 162(1) and 162(2) include a thumbnail start/stop icon 164(1) and 164(2), respectively, a forward icon 166(1) and 166(2), respectively, a reverse icon 168(1) and 168(2), respectively, and a progress bar 170(1), and 170(2), respectively.

In operation, videos are added to simultaneous playback bar 160 by dragging the videos from the video list 96 or other location into the thumbnail start/stop icons 164(1) and 164(2). As the names suggest, these icons 164(1) and 164(2) are also used to start and stop the videos.

Also included in simultaneous playback bar 160 is a lock icon 172. The lock icon 172 places the videos 158(1) and 158(2) in either a locked state or an unlocked state. When in the unlocked stated, the videos may be individually controlled by the above noted controls. However, in the locked state the videos are locked together such that the videos are simultaneously controllable (e.g., simultaneously started, stopped, and paused). When the videos are in the unlocked state, lock icon 172 will be displayed as a broken or open lock. While the videos are in the locked state, the lock icon 172 will be displayed as a complete or closed lock. FIG. 17 illustrates lock icon 172 as an open lock.

Simultaneous playback bar 160 further comprises a toggle icon 174. By tapping toggle icon 174, the user can switch the locations of the videos 158(1) and 158(2) in video area 86 and in simultaneous playback bar 160.

As noted, sections 162(1) and 162(2) include a forward icon 166(1) and 166(2), respectively, and a reverse icon 168(1) and 168(2). In certain embodiments, the videos 158(1) and 158(2) may be played in a frame-by-frame mode by tapping these forward and reverse icons, thereby enabling a user to synch the timing of the simultaneously displayed videos.

Also shown in FIG. 17 is a video screen capture icon 175 that allows the user to record a video of the current display of video area 86. For example, in the arrangement in which two videos are simultaneously displayed side-by-side in video area 86, tapping icon 175 generates a third video that captures the videos side-by-side on the screen. In one embodiment, the video screen capture feature may also capture an audio recording of the audio detected by the microphone and/or output from the computing device during the screen capture.

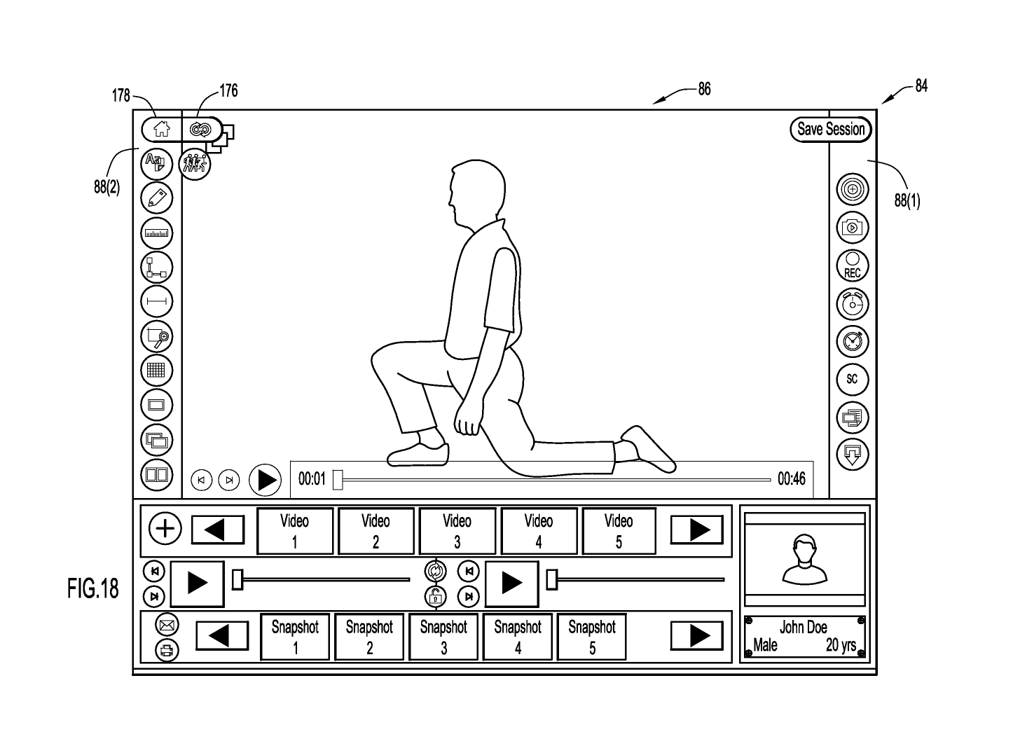

In general, it is expected that users will have a preference of which hand to use to take photographs, snapshots, and videos. Therefore, as shown in FIG. 18, a switch icon 176 is provided. When the user taps the switch icon 176, the location of toolbars 88(1) and 88(2) will be switched. In the above embodiments, tapping the switch icon 176 would cause toolbar 88(1) to appear on the left edge of the control screen 84, while toolbar 88(2) would appear on the right edge of the control screen.

Also identified in FIG. 18 is a home icon 178. When the user taps the home icon 178, the motion capture and analysis application 42 will return to home screen 48.

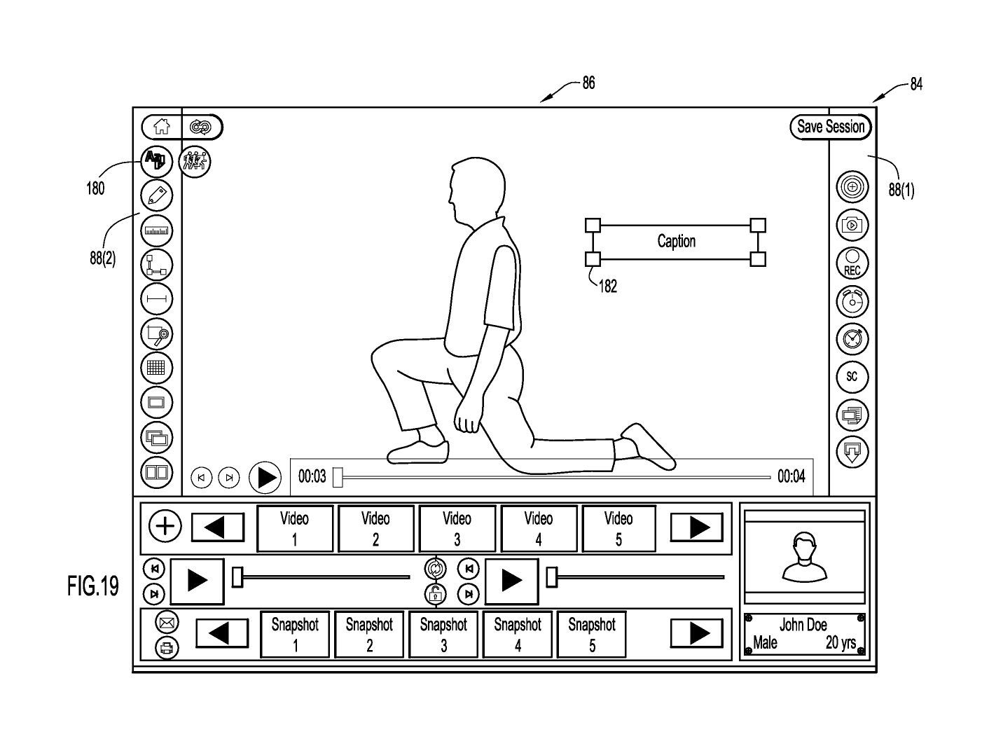

FIG. 19 is a schematic diagram of control screen 84 identifying a text icon 180. When the user taps the text icon 180, a text box 182 will appear in video area 86. When text box 182 is tapped by the user, a keyboard will appear on the screen that allows the user to add a caption to the still-frame image currently displayed on the screen. The text box 182 can be moved and re-sized with touch inputs of the user.

The embodiments of the present invention described above with reference to FIGS. 3-19 generally relate to the setup of sessions and the capture and control of videos/snapshots. The following embodiments generally relate to a plurality of different tools that enable the user to analyze and evaluate a still-frame image displayed in video area 86. As used herein, a still-frame image is a snapshot, photograph, or a paused video that is currently displayed in video area 86.

The disclosed tools are generally and collectively referred to herein as image evaluation tools because that allow the user to evaluate a still-frame image in video area 86. In operation, the image evaluation tools of motion capture and analysis application 42 are superimposed on the still-frame image in video area 86.

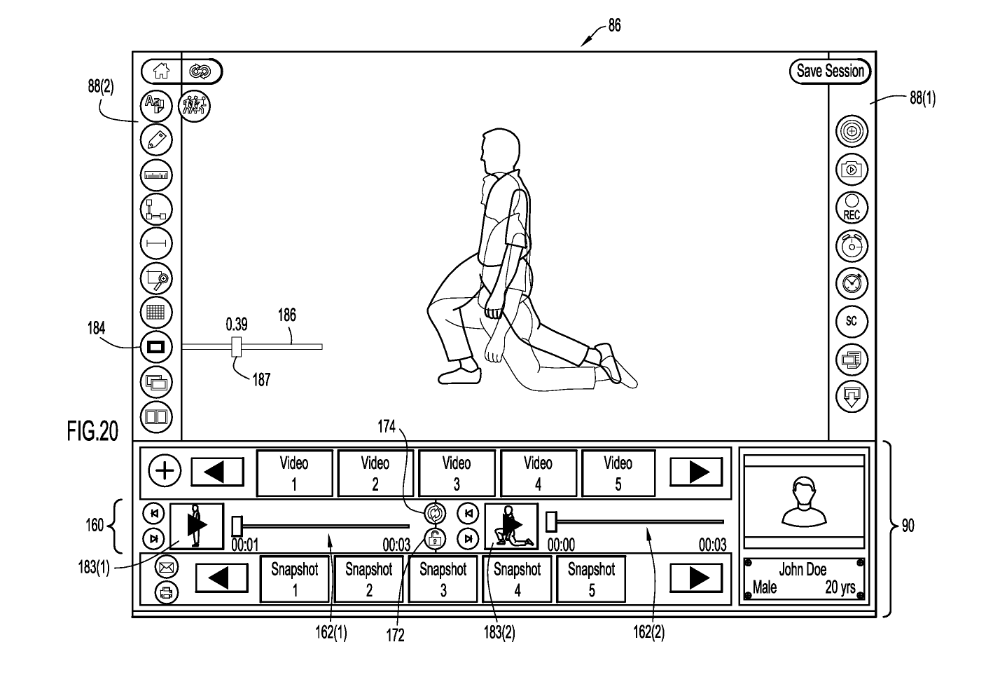

FIG. 20 is a schematic diagram of control screen 84 during use of a simulcast function of motion capture and analysis application 42. Provided in toolbar 88(2) is an overlay icon 184 that allows a user to simulcast two videos within the same portion of video area 86. To simulcast two videos, the user drags the two videos into simultaneous playback bar 160. More specifically, a first video 183(1) is dragged into section 162(1) while the second video 183(2) is dragged into section 162(2). The user then activates the simulcast function by touching overlay icon 184. By overlaying the videos, the user can compare the motions captured in the two different videos.

By default, the video 183(1) in section 162(1) will be overlayed by the video 183(2) in section 162(2). However, the user may switch the videos by tapping toggle icon 174.

When the user touches overlay icon 184, a visibility bar 186 will appear. This visibility bar 186 includes a slider 187 that enables the user to control the opacity (opaqueness) of the overlaying video (i.e., the video in section 162(2)). By changing the opacity of the overlaying video, the user can select how visible each of the videos will be in video area 86. In the embodiment of FIG. 20, the slider 187 is used to set the opacity at a value of approximately 0.39, meaning the video in section 162(2) is 39% opaque in comparison to the video in section 162(1).

Also in the embodiment of FIG. 20, the simulcast videos are in an unlocked state (i.e., lock icon 172 is unlocked). As noted above with reference to FIG. 17, when the videos are in an unlocked state, the user can play/pause the videos individually. The user can touch lock icon 172 to convert the videos to a locked state so that the videos can be simultaneously controlled. Also as noted above, each of the videos may be viewed in a frame-by-frame manner to assist the user in synchronizing the start of the movements captured in the overlaying videos.

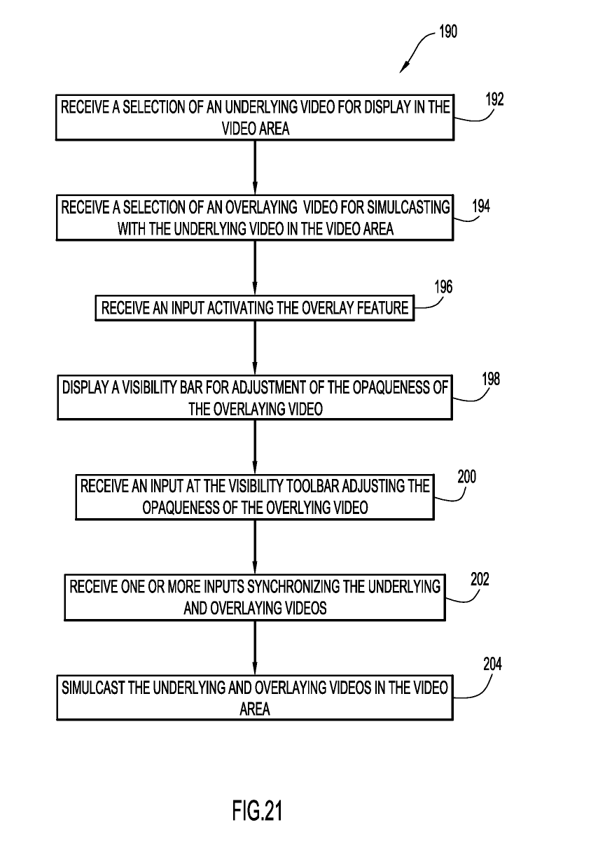

FIG. 21 is a flowchart of a method 190 for execution of the simulcast feature of the motion capture and analysis application 42. Method 190 begins at step 192 where a selection is received of an underlying video for display in the video area 86. The motion capture and analysis application 42 recognizes that such a selection has been made when a video is dragged into section 162(1) of simultaneous playback bar 160. At step 194, a selection is received of an overlaying video for simulcasting with the underlying video in the video area 86. Again, the motion capture and analysis application 42 recognizes that such a selection has been made when a video is dragged into section 162(2) of simultaneous playback bar 160.

At step 196, an input is received that activates the simulcast feature. In these embodiments, the motion capture and analysis application 42 activates the overlay feature in response to the user tapping overlay icon 184. When the overlay feature is activated, the videos in sections 162(1) and 162(2) are displayed in video area 86, and at step 198 the visibility bar 186 is displayed. At step 200, a user input is received that adjusts the opacity of the overlaying video. The motion capture and analysis application 42 receives such inputs when the user slides slider 187 along the visibility bar 186.

At step 202, one or more inputs are received that synchronize the underlying and overlaying videos. That is, the user taps forward icons 166(1)-166(2), or reverse icons 168(1)-168(2) so that the motion captured in each of the underlying and overlying videos is substantially aligned. Once the videos are synchronized, the videos may then be locked using lock icon 172. Finally, at step 204 the underlying and overlaying videos are simulcast in the video area 86.

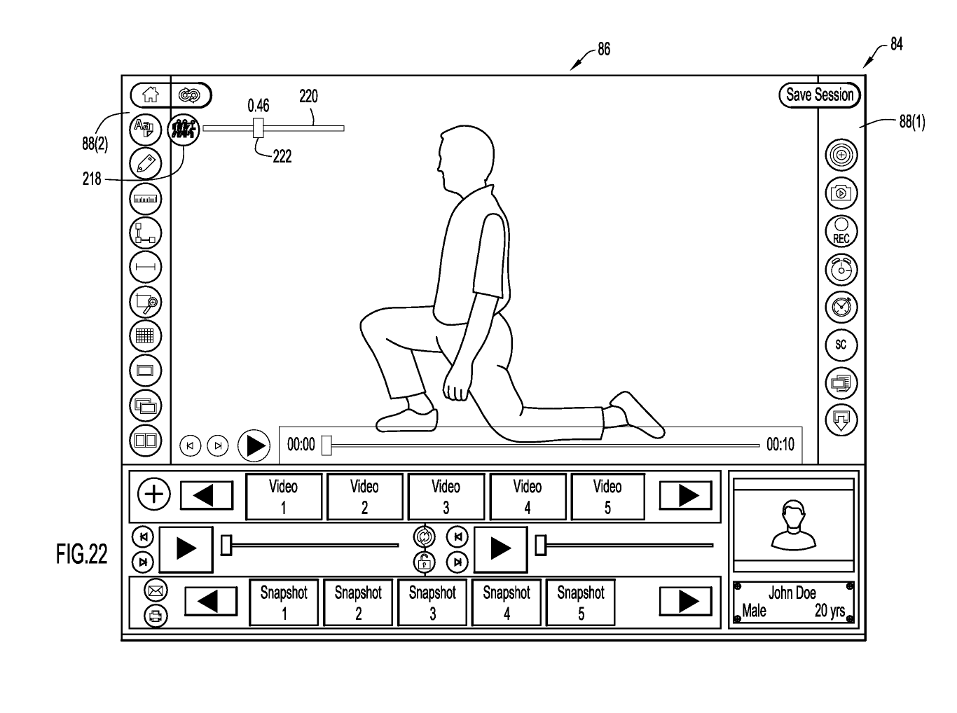

FIG. 22 identifies a slow motion icon 218 that may be used to evaluate a video displayed in video area 86. When slow motion icon 218 is activated, a motion bar 220 appears. Motion bar 220 includes a slider 222 that allows the user to change the speed of the video. In the embodiment of FIG. 22, the slider 222 is used to set the speed at a value of approximately 0.46, meaning the video is playing at 46% the regular (real-time) playback speed.

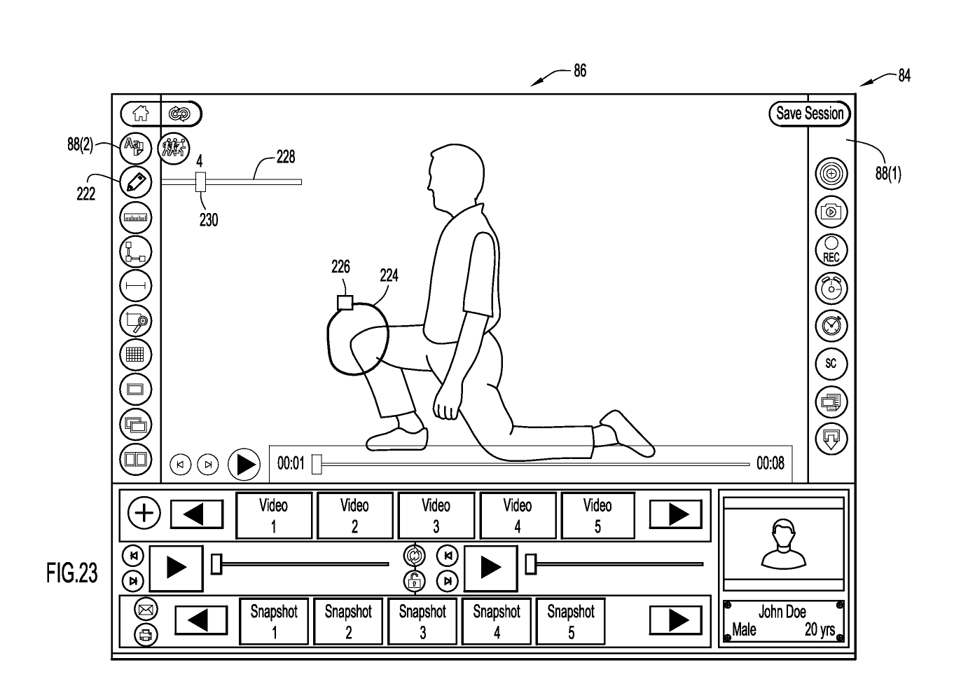

FIG. 23 identifies a chalk icon 222 that allows the user to draw lines or shapes on a still-frame image displayed in video area 86. More specifically, a user taps chalk icon 222 to highlight the icon. The user then uses touch inputs to directly draw the desired line or shape in video area 86. In this embodiment, the user's touch inputs resulted in a circle 224. The circle 224 may be deleted, moved, and/or re-sized/shaped by pressing the square 226. In one specific embodiment, the circle 224 is deleted by holding the center square 226 until a red circle forms. Once the red circle is tapped, the circle 224 is removed from the video area 86.

The thickness of the lines or shapes can be adjusted by using the line weight bar 228 that appears when chalk icon 222 is activated. The thickness of the lines or shapes may be generated based on a scale of 1 to 10, where 10 is the thickest possible line weight. In the embodiment of FIG. 23, a slider 230 may be used to set a relative line weight of 4.

As noted above, the lines or shapes are drawn using chalk icon 222 on top of a snapshot or a paused video. That is, the lines or shapes are superimposed on a still-frame image displayed in video area 86. The lines or shapes will remain on the screen during frame-by-frame playback of the video, but will not be shown during real-time playback.

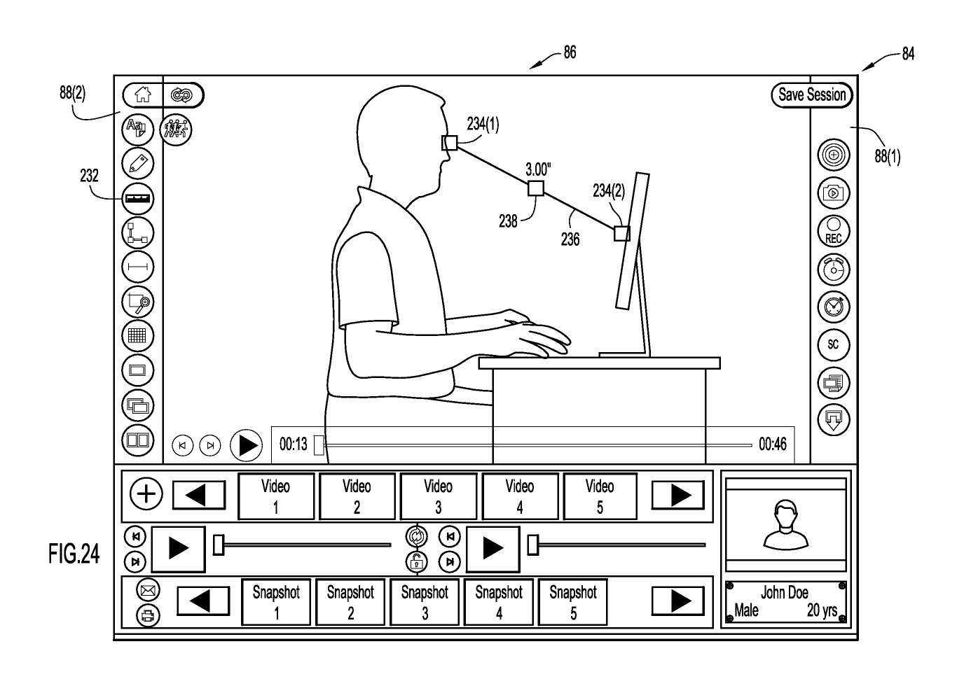

Motion analysis application 42 also provides a user with several different measurement tools. A first such measurement tool is accessible via screen measurement icon 232 that is shown in FIG. 24. Screen measurement icon 232 allows a user to measure the screen distance between two points in a still-frame image displayed in video area 86. In operation, the user touches a first point to superimpose a first end square 234(1) on the image and then a second point to superimpose a second end square 234(2) on the image. The squares 234(1) and 234(2) are then connected by a line 236. A center square 238 appears at the center of the line 236, and the screen distance is displayed above the center square. The user may change the measurement scale between inches and centimeters by tapping square 238. The measurement tools (i.e., the measurement, line, and squares) may be removed from video area 86 by pressing square 238 for a predetermined period of time. In one specific embodiment, the measurement tools are deleted by holding the center square 238 until a red circle forms. Once the red circle is tapped, the measurement tools are removed from the video area 86.

As noted above, the measurement tools are superimposed on a still-frame image displayed in video area 86. These measurement tools will remain on the screen during frame-by-frame playback of the video, but will not be shown during real-time playback.

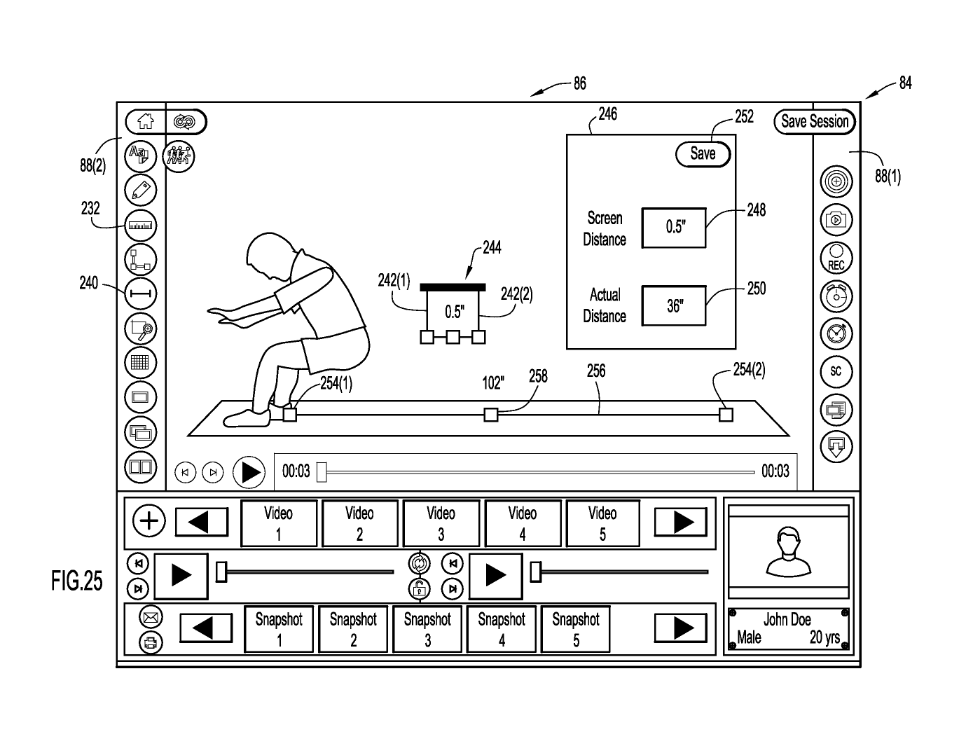

Identified in FIG. 25 is a distance icon 240 that allows the user to measure relative distances within a snapshot or paused video, rather than only screen distance. Before use of the distance icon 240, a user first performs a calibration measurement using measurement icon 232. More specifically, the user measures the screen distance between two points for which the user knows the actual distance. In this embodiment, the user uses screen measurement icon 232 to measure the distance between the legs 242(1) and 242(2) of a table 244 displayed in the video area. The user then taps distance icon 240 that causes a dialog box 246 to appear. Dialog box 246 includes a screen distance field 248 that is populated by the motion capture and analysis application 42 based on the results of the measurement taken with measurement icon 232. The dialog box 246 also includes an actual distance field 250 that is initially blank. The user types the known actual distance in this field 250 and then taps the save icon 252. As used herein, the “actual” distance in a still-frame image is the real distance between the two points, rather than just a screen distance.

After the calibration data is saved, the user touches a first point to superimpose a first end square 254(1) and a second point to superimpose a second end square 254(2) which are then connected by a line 256. A center square 258 appears at the center of the line 256, and a distance is displayed above the center square. Due to the above noted calibration process, the distance displayed above center square 258 is an estimate of the actual or real distance between the two points, rather than simply screen distance. The user may change the measurement scale between inches and feet by tapping center square 258. The measurement tools may be removed from video area 86 by pressing box 258 for a predetermined period of time. In one specific embodiment, the measurement tools are deleted by holding the center square 258 until a red circle forms. Once the red circle is tapped, the measurement tools are removed from the video area 86. The actual distance estimate may remain on the screen during frame-by-frame playback of the video, but will not be shown during real-time playback.

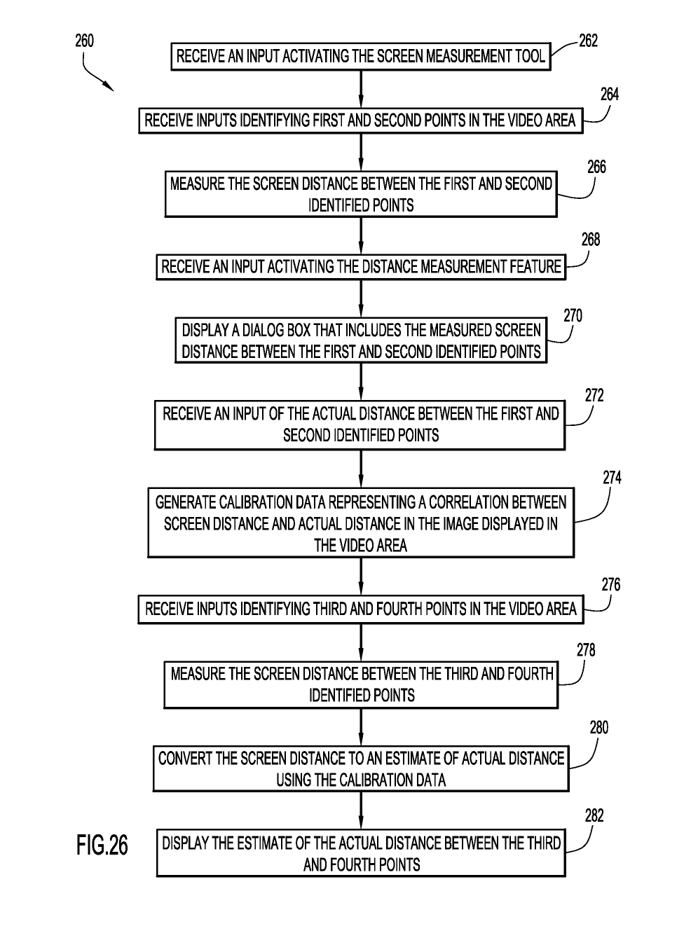

FIG. 26 is a flowchart of a method 260 for execution of the distance measurement feature of the motion capture and analysis application 42. Method 260 begins at step 262 where an input is received that activates the screen measurement tool. The input is received when a user taps the screen measurement icon 232. At step 264, inputs are received that identify first and second points in the video area 86. In practice, these first and second points are points in the image displayed in video are 86 for which the user knows the actual distance separating them (i.e., two legs of a table having a known separation). At step 264, the motion capture and analysis application 42 measures the screen distance between the first and second identified points in video area 86.

At step 268, an input is received that activates the distance measurement feature. This input is received when a user taps the distance icon 240. When the distance measurement feature is activated, the dialog box 246 is displayed in video area 86. As noted above, the dialog box 246 includes the measured screen distance between the first and second points, as well as another field that allows the user to enter the actual distance between the first and second points. At step 272, an input is received that enters the actual distance between the first and second points in the dialog box 246. At step 274, the motion capture and analysis application 42 generates calibration data that represents a correlation (conversion) between screen distance and actual distance in the image currently displayed in the video area 86.

At step 276, inputs are received that identify third and fourth points in the video area 86. At step 278, the motion capture and analysis application 42 measures the distance between the third and fourth points. Subsequently, at step 280, the motion capture and analysis application 42 uses the calibration data to convert the measured screen distance between the third and fourth points into an estimate of the actual distance between the third and fourth points in the captured image. At step 282, the estimate of the actual distance between the third and fourth points is displayed in video area 86.

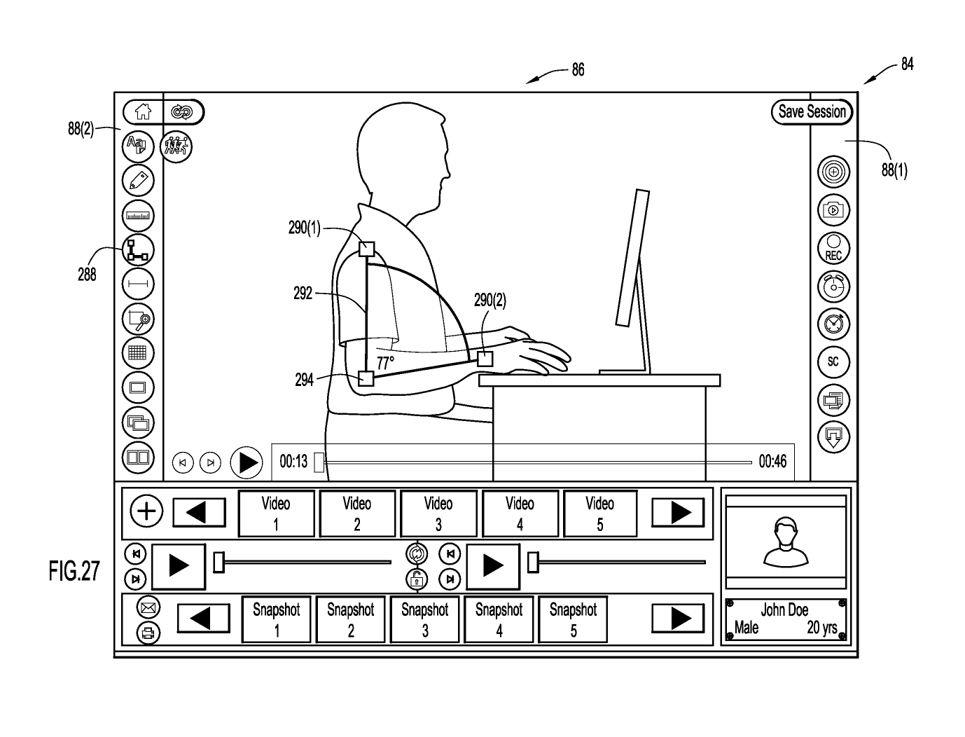

FIG. 27 is a schematic diagram of control screen 84 illustrating a goniometer feature of the motion capture and analysis application 42 that allows a user to draw and measure angles on a still-frame image displayed in video area 86. More specifically, identified in FIG. 27 is an angle icon 288 that a user to activate the goniometer feature. After the goniometer feature is activated, the user touches a first point to superimpose a square 290(1) and a second point to superimpose a square 290(2) onto the displayed image in the video area 86. The squares 290(1) and 290(2) are then connected by a line 292. A center square 294 appears at the center of the line 292. The user then drags the center square 294 to a desired point on the screen for which an angle measurement is desired. This point may be a pivot point such as a subject's elbow, knee, etc. The user may then drag the squares 290(1) and 290(1) to establish the desired angle that is to be measured. The motion capture and analysis application 42 will automatically display the angle (in degrees) near the center square 294. It is to be appreciated that multiple angles may be found in a single snapshot or in a paused video.

The calculated angles and angle tools may be removed from video area 86 by pressing center square 294 for a predetermined period of time and taking one or more other appropriate actions as noted above. These angles and tools may remain on the screen during frame-by-frame playback of a video, but will not be shown during real-time playback.

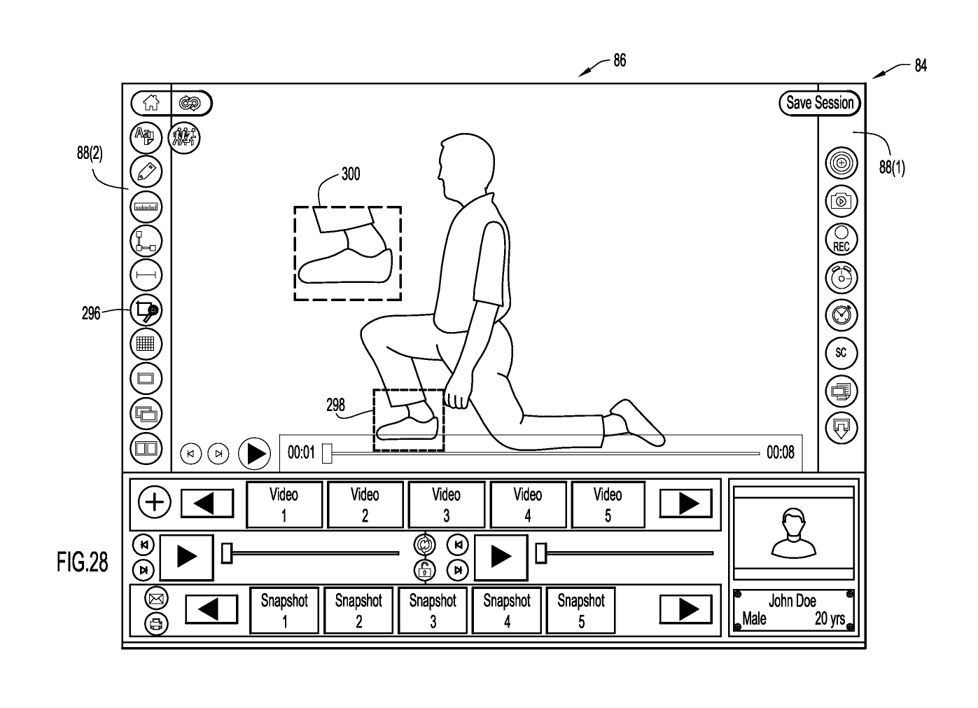

FIG. 28 illustrates a zoom feature of motion capture and analysis application 42 that allows the user to zoom-in on a selected portion of the still-frame image. As shown, toolbar 88(2) includes a zoom icon 296 that allows the user to draw a square 298 in video area 86 around a portion of the displayed image that should be enlarged. After the square 298 is drawn by the user, the motion capture and analysis application 42 will display a zoom box 300 that provides a zoomed-in view of the image contained in square 298. Square 298 and box 300 may be moved and re-sized by touch inputs.

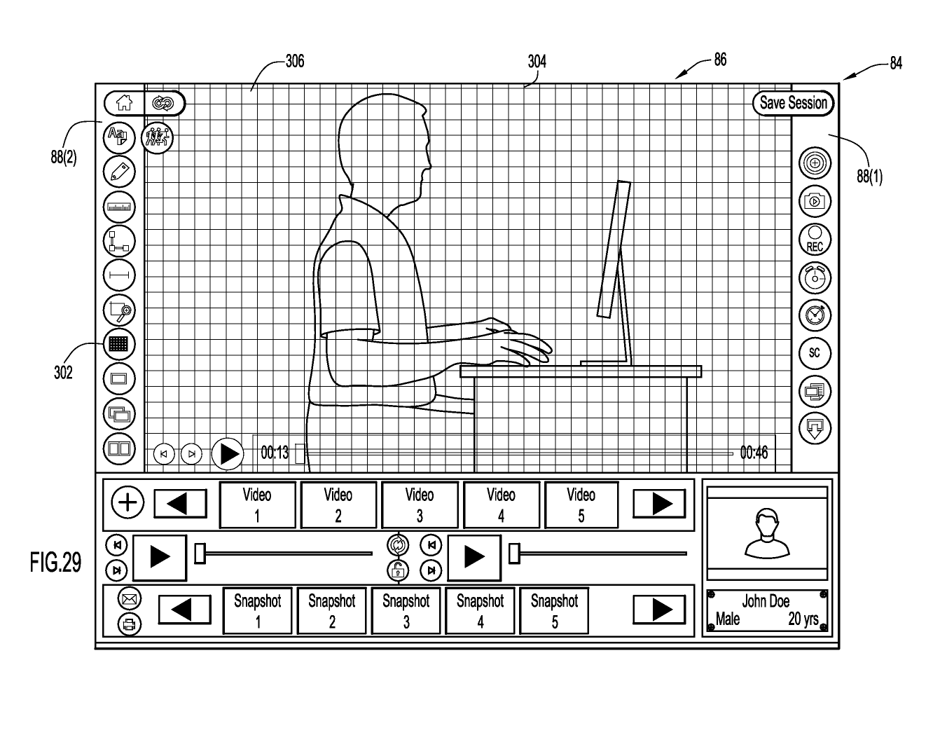

FIG. 29 is a schematic diagram of control screen 84 illustrating a grid feature of the motion capture and analysis application 42. More specifically, toolbar 88(2) includes a grid icon 302 that, when activated, superimposes a grid 304 onto a image displayed in video area 86. The cells 306 within the grid 304 may be moved and re-sized through touch inputs. The grid 304 assists the user in evaluating a subject's motion by, for example, providing reference points over the displayed image.

The grid 304 may be removed from video area 86 by re-tapping the grid icon 302. The grid 304 may remain on the screen during frame-by-frame playback of a video, but will not be shown during real-time playback.

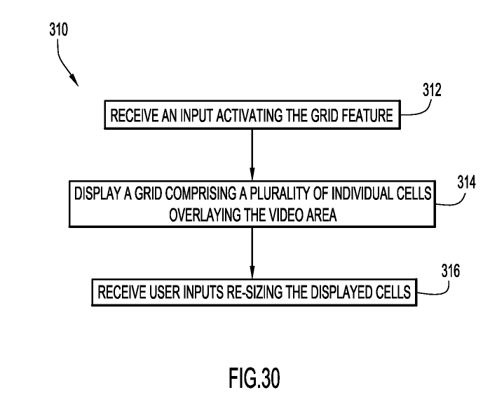

FIG. 30 is a flowchart of a method 310 for execution of the grid feature of the motion capture and analysis application 42. At step 312, an input is received that activates the grid feature. The input may be a user tapping the grid icon 302. In response to the input, at step 314 the motion capture and analysis application 42 displays the grid 304 superimposed on the video area 86. As noted, the grid 304 includes a plurality of individual cells 306. At 316, one or more user inputs are received that re-size/re-position the displayed cells.

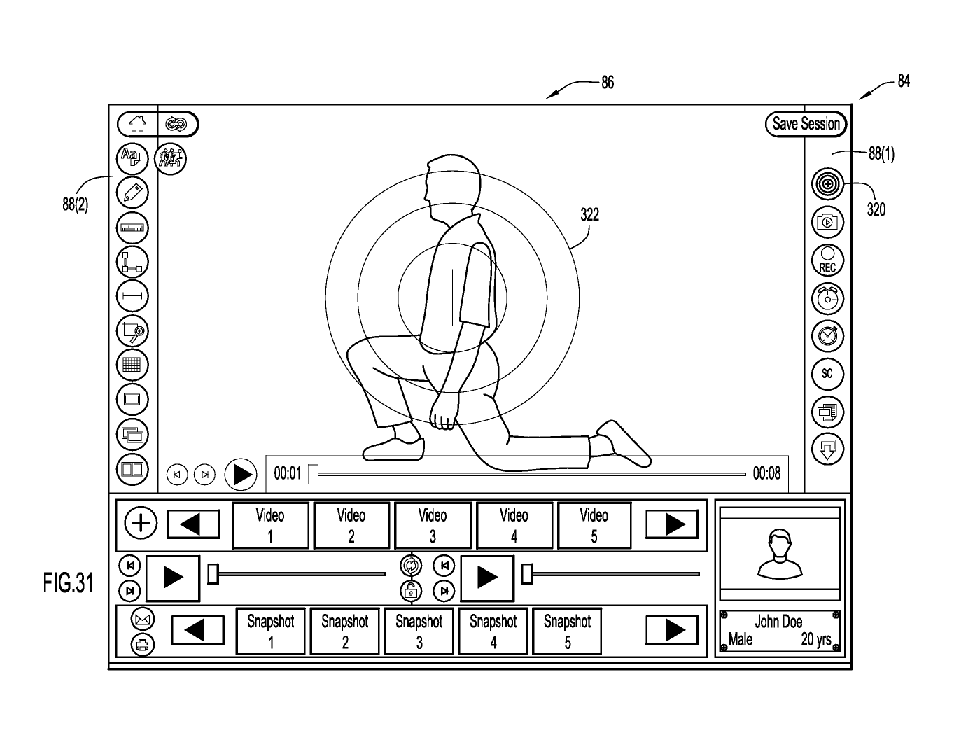

FIG. 31 is a schematic diagram of control screen 84 illustrating a bull's-eye feature of the motion capture and analysis application 42. More specifically, identified in toolbar 88(1) is a bull's-eye icon 320 that, when tapped by a user, superimposes a bull's-eye 322 onto video area 86. The bull's-eye 322 may be resized, re-positioned, spun (rotated) or otherwise adjusted using touch inputs received in video area 86. For ease of illustration, FIG. 31 illustrates the bulls-eye 322 as a two-dimensional sphere. In an alternative embodiment, the bull's-eye 322 may be displayed as a three dimensional sphere that, in operation, may appear to surround the subject that appears in the displayed image. The use of such a three dimensional bull's-eye allows the user to adjust the sphere around the subject so as to account for the distance the subject is from the camera.

The bull's-eye 322 may be removed from video area 86 by re-tapping the bull's-eye icon 320. The bull's-eye 322 may remain on the screen during frame-by-frame playback of a video, but will not be shown during real-time playback.

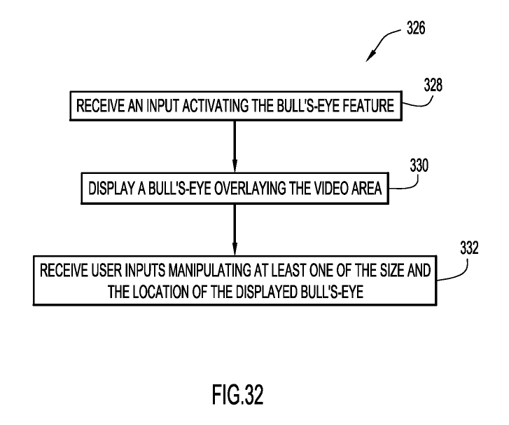

FIG. 32 is a flowchart of a method 326 for execution of the bull's-eye feature of the motion capture and analysis application 42. At step 328, an input is received that activates the bull's-eye feature. The input may be a user tapping the bull's-eye icon 320. In response to the input, at step 330 the motion capture and analysis application 42 displays the bull's-eye 322 superimposed on the video area 86. At step 332, one or more user inputs are received that at least one of re-size or change the location of the displayed bull's-eye 322.

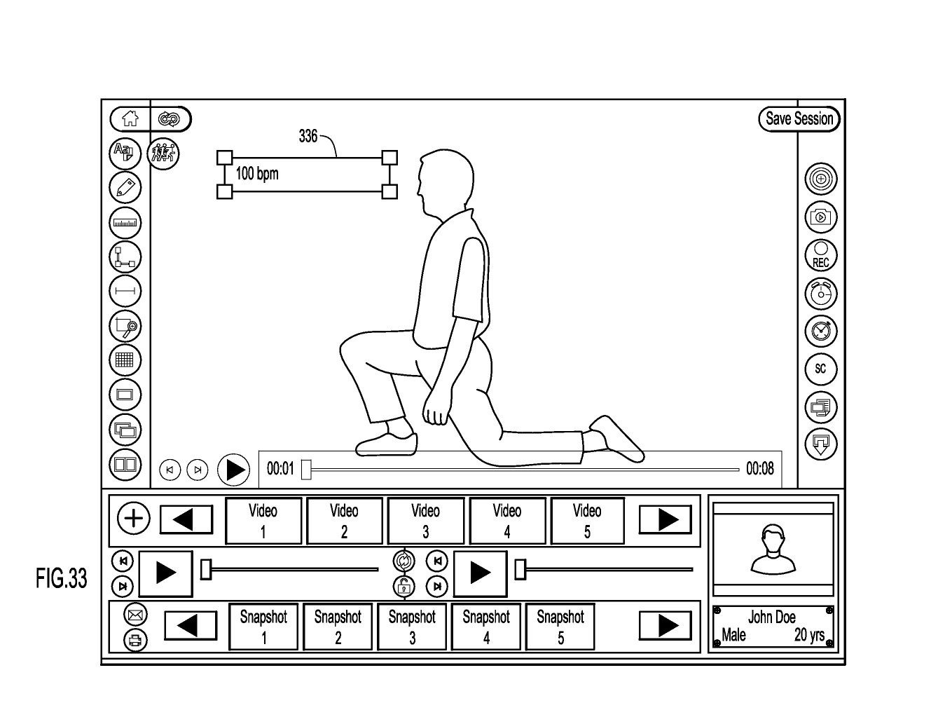

Motion capture and analysis application 42 may be configured to integrate with a number of different external devices to provide one or of the above or other features. For example, in certain circumstances a subject may wear a heart rate monitor during a captured workout. As shown in FIG. 33, the motion capture and analysis application 42 may be configured to receive information from the external heart rate monitor to display the subject's heart rate in a box 336 in video area 86. In such an embodiment, radio frequency transmissions from the heart rate monitor would be received at transceiver(s) 26. The motion capture and analysis application 42 would then use the received signals to display the captured heart rate.

Cooperation with a heart rate monitor is only one specific example of the ability of motion capture and analysis application 42 to integrate with external devices. In another embodiment, video and/or photograph capture may be controlled from another device, such as laptop, mobile phone, etc. In embodiments in which a phone is used to control recording, a user could place the portable computing device 10 on a tripod and watch the subject with his/her own eyes, rather than through the portable computing device.

In a still other integration embodiment, the motion capture and analysis application 42 may be configured to receive a wireless feed from an external camera. In such embodiments, the external camera may be positioned so as to capture a different view of the subject that may be evaluated using the above described features. This feature would allow trainers to capture video of the subject from several different vantage points.

Furthermore, as the motion capture and analysis application 42 is executed on a portable computing device 10 that may have limited storage capabilities, the application is configured to off-load saved videos, snapshots, and photographs to external storage devices. In one specific embodiment, the motion capture and analysis application 42 is configured to wirelessly upload data to network (cloud) storage.

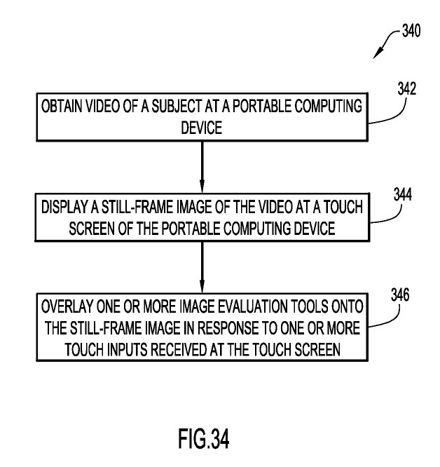

FIG. 34 is a high-level flowchart of a method 340 implemented in accordance with embodiments of the present invention. At step 342, a video of a subject is obtained at a portable computing device. In one embodiment, the video may be obtained by capturing the video with a video recorder of the portable computing device. In another embodiment, the video may be obtained by accessing a previously recorded video from at least one of a local or an external storage location.

At step 344, a still-frame image (e.g., snapshot or a paused image of a video) is displayed at a touch screen of the portable computing device. At step 346, in response to one or more touch inputs received at the touch screen, one or more image evaluation tools are superimposed on the still-frame image. The image evaluation tools may include, for example, the bull's-eye tool, angle measurement tool, screen measurement tool, actual distance measurement tool, chalk tool, zoom tool, grid tool, etc.

It will be appreciated that the above description and accompanying drawings represent only a few of the many ways of implementing a method and apparatus for motion capture and analysis in accordance with embodiments of the present invention.

The environment of embodiments of the present invention embodiments may include a number of different portable computing devices (e.g., IBM-compatible, Apple, Macintosh, tablet computer, palm pilot, mobile phone, etc.). The portable computing devices may also include any commercially available operating system (e.g., Windows, iOS, Mac OS X, Unix, Linux, etc.) and any commercially available or custom software. These systems may include any type of touch screen implemented alone or in combination with other input devices (e.g., keyboard, mouse, voice recognition, etc.) to enter and/or view information.

It is to be understood that the software (e.g., motion capture and analysis application.) may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry. The various functions of the computer systems may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). The software and/or algorithms described above and illustrated in the flow charts may be modified in any manner that accomplishes the functions described herein. In addition, the functions in the flow charts or description may be performed in any order that accomplishes a desired operation.

A portable computing device executing the motion capture and analysis application may operate with a number of different communication networks (e.g., LAN, WAN, Internet, Intranet, VPN, etc.). The portable computing device may include any conventional or other communications devices to communicate over the network via any conventional or other protocols. The portable computing device may also utilize any type of connection (e.g., wired, wireless, etc.) for access to a network.

Embodiments of the present invention can take the form of an entirely hardware embodiment, an entirely software embodiment or an embodiment containing both hardware and software elements. In a preferred embodiment, the invention is implemented in software, which includes but is not limited to firmware, resident software, microcode, data structures, APIs, etc.

Furthermore, embodiments of the present invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The software of embodiments of the present invention embodiments may be available on a recordable medium (e.g., magnetic or optical mediums, magneto-optic mediums, floppy diskettes, CD-ROM, DVD, memory devices, etc.) for use on stand-alone systems or systems connected by a network or other communications medium, and/or may be downloaded (e.g., in the form of carrier waves, packets, etc.) to systems via a network or other communications medium.

Having described embodiments of a new and improved method and apparatus for capturing and analyzing videos at a portable computing device, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A method comprising:
obtaining a video of a subject at a portable computing device;
displaying a still-frame image of the video at a touch screen of the portable computing device; and
superimposing one or more image evaluation tools onto the still-frame image in response to one or more touch inputs received at the touch screen.

2. The method of claim 1, wherein obtaining the video of the subject comprises:
capturing the video with a video recorder integrated in the portable computing device.

3. The method of claim 1, wherein obtaining the video of the subject comprises:
accessing a previously recorded video from at least one of a local or an external storage location.

4. The method of claim 1, wherein superimposing the one or more image evaluation tools onto the still-frame image comprises:
superimposing a grid having a plurality of cells onto the still-frame image, wherein the plurality of cells are configured to be adjustable in one or more of size and position in response to touch inputs received at the touch screen.

5. The method of claim 1, wherein superimposing the one or more image evaluation tools onto the still-frame image comprises:
superimposing an adjustable bull's-eye onto the still-frame image, wherein the bull's-eye is configured to be adjusted in one or more of size, position, and orientation in response to touch inputs received at the touch screen.

6. The method of claim 1, wherein superimposing the one or more image evaluation tools onto the still-frame image comprises:
superimposing an angle measurement tool onto the still-frame image, wherein the angle measurement tool is adjustable in one or more of size, position, and orientation in response to touch inputs received at the touch screen in order to measure an angle in the still-frame image.

7. The method of claim 1, wherein superimposing the one or more image evaluation tools onto the still-frame image comprises:
receiving touch inputs drawing at least one of a line or a shape on the still-frame image; and
displaying the line or the shape on the still-frame image in response to the touch inputs.

8. The method of claim 1, wherein superimposing one or more image evaluation tools onto the still-frame image comprises:
receiving touch inputs identifying a selected portion of the still-frame image; and
displaying an enlarged view of the selected portion of the still-frame image on the touch screen.

9. The method of claim 1, wherein superimposing one or more image evaluation tools onto the still-frame image comprises:
receiving a first touch input at the touch screen identifying a first point in the still-frame image;
receiving a second touch input at the touch screen identifying a second point in the still-frame image;
measuring a screen distance between the first and second points in the still-frame image; and
displaying the screen distance between the first and second points in the still-frame image on the touch screen.

10. The method of claim 9, further comprising:
receiving one or more touch inputs providing the actual distance between the first and second points in the still-frame image;
generating calibration data correlating the measured screen distance between the first and second points in the still-frame image and the actual distance between the first and second points in the still-frame image;
receiving a third touch input at the touch screen identifying a third point in the still-frame image;
receiving a fourth touch input at the touch screen identifying a fourth point in the still-frame image;
measuring a screen distance between the third and fourth points in the still-frame image;
converting the measured screen distance between the third and fourth points in the still-frame image to an estimate of the actual distance between the third and fourth points in the still-frame image; and
displaying the estimate of the actual distance between the third and fourth points in the still-frame image on the touch screen.

11. The method of claim 1, wherein obtaining the video of a subject comprises:
obtaining a first video of a subject; and
obtaining a second video of a subject.

12. The method of claim 11, further comprising:
simultaneously playing the first and second videos side-by-side on the touch screen of the portable computing device.

13. The method of claim 11, further comprising:
simulcasting the first and second videos on the touch screen such that the first video is overlayed by the second video.

14. The method of claim 13, further comprising:
adjusting the opacity of the second video based on one or more touch inputs received at the touchscreen.

15. The method of claim 1, further comprising:
performing a video screen capture of the touchscreen in response to a touch input.

16. One or more computer readable storage media encoded with software comprising computer executable instructions and when the software is executed operable to:
obtain a video of a subject at a portable computing device;
display a still-frame image of the video at a touch screen of the portable computing device; and
superimpose one or more image evaluation tools onto the still-frame image in response to one or more touch inputs received at the touch screen.

17. The computer readable storage media of claim 16, wherein the instructions operable to obtain the video of the subject comprise instructions operable to:
capture the video with a video recorder integrated in the portable computing device.

18. The computer readable storage media of claim 16, wherein the instructions operable to obtain the video of the subject comprise instructions operable to:
access a previously recorded video from at least one of a local or an external storage location.

19. The computer readable storage media of claim 16, wherein the instructions operable to superimpose the one or more image evaluation tools onto the still-frame image comprise instructions operable to:
superimpose a grid having a plurality of cells onto the still-frame image, wherein the plurality of cells are configured to be adjustable in one or more of size and position in response to touch inputs received at the touch screen.

20. The computer readable storage media of claim 16, wherein the instructions operable to superimpose the one or more image evaluation tools onto the still-frame image comprise instructions operable to:
superimpose an adjustable bull's-eye onto the still-frame image, wherein the bull's-eye is configured to be adjusted in one or more of size, position, and orientation in response to touch inputs received at the touch screen.

21. The computer readable storage media of claim 16, wherein the instructions operable to superimpose the one or more image evaluation tools onto the still-frame image comprise instructions operable to:
superimpose an angle measurement tool onto the still-frame image, wherein the angle measurement tool is adjustable in one or more of size, position, and orientation in response to touch inputs received at the touch screen in order to measure an angle in the still-frame image.

22. The computer readable storage media of claim 16, wherein the instructions operable to superimpose the one or more image evaluation tools onto the still-frame image comprise instructions operable to:
receive touch inputs drawing at least one of a line or a shape on the still-frame image; and
superimpose the line or the shape on the still-frame in response to the touch inputs.

23. The computer readable storage media of claim 16, wherein the instructions operable to superimpose the one or more image evaluation tools onto the still-frame image comprise instructions operable to:
receive touch inputs identifying a selected portion of the still-frame image; and
display an enlarged view of the selected portion of the still-frame image on the touch screen.

24. The computer readable storage media of claim 16, wherein the instructions operable to superimpose the one or more image evaluation tools onto the still-frame image comprise instructions operable to:
receive a first touch input at the touch screen identifying a first point in the still-frame image;
receive a second touch input at the touch screen identifying a second point in the still-frame image;
measure a screen distance between the first and second points in the still-frame image; and
display the screen distance between the first and second points in the still-frame image on the touch screen.

25. The computer readable storage media of claim 24, further comprising instructions operable to:
receive one or more touch inputs providing the actual distance between the first and second points in the still-frame image;
generate calibration data correlating the measured screen distance between the first and second points in the still-frame image and the actual distance between the first and second points in the still-frame image;
receive a third touch input at the touch screen identifying a third point in the still-frame image;
receive a fourth touch input at the touch screen identifying a fourth point in the still-frame image;
measure a screen distance between the third and fourth points in the still-frame image;
convert the measured screen distance between the third and fourth points in the still-frame image to an estimate of the actual distance between the third and fourth points in the still-frame image; and
display the estimate of the actual distance between the third and fourth points in the still-frame image on the touch screen.

26. The computer readable storage media of claim 16, wherein the instructions operable to obtain the video of a subject comprise instructions operable to:
obtain a first video of a subject; and
obtain a second video of a subject.

27. The computer readable storage media of claim 26, further comprising instructions operable to:
simultaneously playing the first and second videos side-by-side on the touch screen of the portable computing device.

28. The computer readable storage media of claim 26, further comprising instructions operable to:
simulcast the first and second videos on the touch screen such that the first video is overlayed by the second video.

29. The computer readable storage of claim 28, further comprising instructions operable to:
adjust the opaqueness of the second video based on one or more touch inputs received at the touchscreen.

30. The computer readable storage of claim 16, further comprising instructions operable to:
perform a video screen capture of the touchscreen in response to a touch input.
